(19) United States
(12) Patent Application Publication
(10) Pub. No.: US 2024/0414570 A1
(43) Pub. Date: Dec. 12, 2024

(54) NEXT GENERATION CONTROLS INCLUDING COOPERATIVE GESTURE AND MOVEMENT DETECTION USING WIRELESS SIGNALS

(71) Applicant: Adeia Guides Inc., San Jose, CA (US)

(72) Inventors: Kamal J. Koshy, Aurora, CO (US); Dhananjay Lal, Englewood, CO (US)

(21) Appl. No.: 18/208,630

(22) Filed: Jun. 12, 2023

(51) Int. Cl. H04W 24/08; G06F 3/01

(52) U.S. Cl. CPC H04W 24/08; G06F 3/017

(57) ABSTRACT

Methods and systems are described for gesture and movement detection using wireless signals. Peer devices collaborate to detect hand and/or finger gestures. Gesture detection using one or more cooperative devices is provided. The gesture is detected cooperatively in a session. Device-to-device gesture detection improves accuracy such that fine motor gestures are inferred. Artificial intelligence systems, including neural networks, are trained for improving the gesture and movement detection. Models are developed for the gesture and movement detection. Related apparatuses, devices, techniques, and articles are also described.

### FIELD OF THE INVENTION

The present disclosure relates to next generation controls. The next generation controls include enhanced gesture detection using wireless signals. The next generation controls and the enhanced gesture detection are provided for extended reality (XR) sessions including XR, augmented reality (AR), three-dimensional (3D) content, four-dimensional (4D) experiences, next-generation user interfaces (next-gen UIs), virtual reality (VR), mixed reality (MR) experiences, interactive experiences, and the like. The next generation controls and the enhanced gesture detection improve accuracy of detection and overall user experience.

### SUMMARY

In some approaches, wireless gesture detection is restricted to allow for gesture detection in close proximity (e.g., within a typical room, i.e., less than or equal to a range from about five feet to about 30 feet or about 1.524 meters to about 9.144 meters) to a wireless access point; relatively large scale and coarse movements (e.g., gross body movements) are detectable but relatively small scale and fine movements are not; accuracy is severely limited with increasing distance; a gesture for detection must be in a direct path of a wireless signal; and specialized hardware is required. A need has arisen for improvement of gesture detection.

Peer devices collaborate to improve detection of gestures. Gestures include movements of a user's body including movements of fingers, phalanges, hands, arms, legs, the head, and the like. Gesture detection using one or more cooperative devices is provided. The gesture is detected cooperatively in a session. Device-to-device gesture detection improves accuracy such that fine motor gestures are, in some embodiments, detected and/or inferred.

Gesture detection accuracy depends on proximity, a wireless path, and processing. The proximity of a wireless transmitter and a wireless receiver to a user whose gestures are being detected affects accuracy. Also, user gestures impact the wireless channel. Channel changes are detected at the receiver as, for example, received signal strength indicator (RSSI) modifications, channel state information (CSI) changes, a Doppler effect or Doppler shift, and/or a frequency shift in the received signal. Further, improved methods for processing the signals are provided.

A process for determining the best possible pair or group of devices for gesture detection is provided. Additional peer-to-peer (P2P) and/or router-client connections are formed to provide a rich wireless environment. Gestures from the user are detected by a peer device located in a vicinity of the user. The additional connections enhance the reliability of gesture detection.

Various processes are provided for enhancing the proximity and wireless path for gesture detection. Communication between a single client device to an access point is provided, in some instances, as a default process. In addition, a single P2P connection is provided. The P2P connection is formed between two devices in the vicinity of the user, in addition to or in lieu of a communication between a client device and a router. The devices forming the P2P connection detect the gestures more accurately due to the proximity to the user. Further, multiple P2P connections are provided. The multiple P2P connections are formed with devices in the vicinity of the user to enhance the detection of user gestures. Still further, additional client-access point connections are provided. Additional devices in the vicinity of the user communicate with the access point to create an environment where wireless gestures are detected.

Connections that have a higher number of principal components have higher probability for detecting the user gesture accurately and are selected for communication. In some embodiments, gesture detection accuracy is enhanced by selecting peer devices that capture the gesture based on a tuned artificial intelligence and/or machine learning model trained on time-series changes that occur in wireless CSI.

The present invention is not limited to the combination of the elements as listed herein and may be assembled in any combination of the elements as described herein.

These and other capabilities of the disclosed subject matter will be more fully understood after a review of the following figures, detailed description, and claims.

### BRIEF DESCRIPTIONS OF THE DRAWINGS

The present disclosure, in accordance with one or more various embodiments, is described in detail with reference to the following figures. The drawings are provided for purposes of illustration only and merely depict non-limiting examples and embodiments. These drawings are provided to facilitate an understanding of the concepts disclosed herein and should not be considered limiting of the breadth, scope, or applicability of these concepts. It should be noted that for clarity and ease of illustration these drawings are not necessarily made to scale.

The embodiments herein may be better understood by referring to the following description in conjunction with the accompanying drawings, in which like reference numerals indicate identical or functionally similar elements, of which:

FIG. 1 depicts a first scenario for gesture detection, in accordance with some embodiments of the disclosure;

FIG. 2 depicts a second scenario for gesture detection, in accordance with some embodiments of the disclosure;

FIG. 3 depicts a reference coordinate system for FIGS. 1 and 2, in accordance with some embodiments of the disclosure;

FIG. 4 depicts a wireless detection system with a wireless access point and a mobile device, in accordance with some embodiments of the disclosure;

FIG. 5 depicts a wireless detection system with a peer-to-peer connection between a pair of mobile phones, in accordance with some embodiments of the disclosure;

FIG. 6 depicts a wireless detection system with a peer-to-peer connection between an AR/VR headset and a mobile phone, in accordance with some embodiments of the disclosure;

FIG. 7 depicts a wireless detection system with a peer-to-peer connection between an AR/VR headset and a television, in accordance with some embodiments of the disclosure;

FIG. 8 depicts a wireless detection system with a peer-to-peer connection between an smartphone and a smartwatch, in accordance with some embodiments of the disclosure;

FIG. 9 depicts a wireless detection system with multiple peer-to-peer connections between an AR/VR headset, a smartphone, a smartwatch, and a smart television, in accordance with some embodiments of the disclosure;

FIG. 10A is a flowchart of a first portion of a process for device selection, in accordance with some embodiments of the disclosure;

FIG. 10B is a flowchart of a second portion of the process for device selection, in accordance with some embodiments of the disclosure;

FIG. 11 depicts reconstruction loss versus a number of principal components analysis (PCA) components, in accordance with some embodiments of the disclosure;

FIG. 12 depicts a system for gesture detection including a neural network, in accordance with some embodiments of the disclosure;

FIG. 13 depicts a first user interface for device selection, in accordance with some embodiments of the disclosure;

FIG. 14 depicts a second user interface displayed during an active gesture detection session, in accordance with some embodiments of the disclosure;

FIG. 15 is a flowchart of a process for gesture detection, in accordance with some embodiments of the disclosure;

FIG. 16 depicts an artificial intelligence system, in accordance with some embodiments of the disclosure; and

FIG. 17 depicts a system including a server, a communication network, and a computing device for performing the methods and processes noted herein, in accordance with some embodiments of the disclosure.

The drawings are intended to depict only typical aspects of the subject matter disclosed herein, and therefore should not be considered as limiting the scope of the disclosure. Those skilled in the art will understand that the structures, systems, devices, and methods specifically described herein and illustrated in the accompanying drawings are non-limiting embodiments and that the scope of the present invention is defined solely by the claims.

### DETAILED DESCRIPTION

Internet-of-things (IoT) devices and audio-controlled devices have become ubiquitous recently with widespread adoption of smart devices by consumers. These devices are used to control multiple and varied functions in the home using audio commands from the user. Also, AR/VR headsets and entertainment systems are increasingly adopted by consumers, at least in part due to recent advances in immersing consumers in AR/VR worlds. Further, video game consoles and supported interactive gaming experiences are increasingly popular.

Gesture recognition is provided for myriad devices including game consoles, personal computers, mobile phones, and the like. Gesture recognition without vision processing or in addition to vision processing is provided. Gesture recognition is based on various inputs including different types of expressions, movements, gestures, and the like, which include facial expressions, hand gestures, and/or body movements, and the like.

Facial expression detection including supervised learning, deep neural networks, and/or a camera sensor, and the like is provided. Also, facial expression including image segmentation and/or classification is provided.

Hand gesture detection including a hand movement is provided. Hand gesture and/or movement including a finger gesture and/or movement is provided. Hand movement detection including image classification and/or segmentation is provided. In addition, mechanical, magnetic, electromagnetic, and/or ultrasonic sensors for detecting hand movement are provided.

Body movement detection is provided. Body movement detection including gross motor movement detection is provided. Gross motor movement detection including moving limbs, turning the body, and the like is provided. Body movement detection including processes similar to hand gesture detection is provided. In some embodiments, body movement detection is relatively easier to detect due to higher relative movement compared to facial and hand gestures.

Classification processes are provided for gesture detection. Gesture detection is provided using hidden Markov model (HMM), deep learning, and/or machine learning processes, and the like. The HMM process is applied to sensor data from mechanical, magnetic, electromagnetic, and/or ultrasonic sensors. The deep learning process is applied to sensor data from image and/or camera sensors.

In wireless communications, RSSI is a metric that refers to a strength of a signal received by a wireless receiver. RSSI is utilized as a coarse-level metric. RSSI indicates a quality of a wireless link between a transmitter and a receiver. RSSI is impacted by a communication medium. RSSI encounters interference and/or fading caused by objects, and movements of objects that impact reflection, scattering, and diffraction of wireless signals.

In wireless communications, “CSI” refers to known or previously verified channel properties of a communication link. Wireless channel sounding is provided. The wireless channel sounding is part of a communication protocol, in some embodiments. Wireless channel sounding includes sending a known or previously verified transmitted signal from a transmitter to a receiver. The receiver receives the signal and uses the received signal to analyze channel characteristics. Channel sounding is provided in single-carrier and multi-carrier transmission systems like orthogonal frequency division multiplexing (OFDM) and orthogonal frequency division multiplexing access (OFDMA), which is an extension of OFDM. In addition, channel sounding is used in wideband and narrowband systems, in some embodiments. Channel sounding is provided to build a CSI matrix for a channel. The CSI matrix includes the channel between the transmitter and the receiver at each of the subcarriers within OFDM.

Wireless-based or Wi-Fi-based gesture detection is provided. Gesture detection is performed by monitoring a wireless reflector. As the reflector moves, the reflector induces a frequency shift in a received signal. The frequency shift is observed in many wireless and non-wireless systems. When there is motion, the frequency shift is referred to as a Doppler shift. The Doppler shift pattern induced by a gesture is classified into a gesture pattern. Disambiguation of a polarity of the Doppler shift (for example, based on whether a user is facing away or towards the receiver) is provided by comparison with a gesture pattern. In addition to detecting body gestures and/or gross movements, hand gestures are detected at sufficiently high reliability.

Multiple gesture detection processes are provided using wireless communications including CSI, Frequency-Modulated Carrier Wave (FMCW), RSSI, Doppler shift, and the like. CSI measurements in wireless systems detect changes in a wireless medium. The changes in the wireless medium are triggered by gestures from the user's body. That is, wireless CSI is used to detect user gestures. CSI detection is provided to accurately detect relatively intricate gestures. Accuracy of the CSI detection is improved to compensate for a tendency for the accuracy to decrease as the user moves away from the transmitter or receiver.

In addition, accuracy of the CSI detection is improved by providing input to the system even when a user's body or gesture is not necessarily in a path of the wireless signal or when the user's body or gesture is at least partially obscured. FMCW-based gesture detection is improved by detecting the frequency shift caused by different gestures without a need for specialized hardware supporting a unique waveform for FMCW. RSSI-based gesture detection is improved to detect and differentiate between gestures with relatively fine distinctions, i.e., fine motor gestures. Doppler-shift-based gesture detection is also improved.

The present methods and systems overcome a tendency for wireless parameters (including, e.g., RSSI and CSI) to decay in value over distance. In some instances, the decay is due to physical characteristics of the wireless medium. An effectiveness of wireless gesture detection over distance is improved. Systems are configured to accommodate for situations where either the wireless transmitter or receiver is away from or blocked from the user's body. Compensation for exponential reduction in signal strength over distance is provided. Relatively high communication speed over distance is provided.

A signal-to-noise ratio (SNR) of a Doppler shift reduces over distance. Based on the specific characteristics of the room, Doppler SNR stays relatively constant (for example, multi-path reflections compensating for longer distances), in some embodiments. In addition, a wireless CSI matrix contains information from which a Doppler shift is inferred. That is, the wireless CSI matrix provides a channel transfer matrix and incorporates frequency shift over time from which Doppler shift is calculated. Wireless CSI also incorporates additional information including fading information caused by obstructions (for example, when detecting hand movement) that is useful in detecting gestures.

Fine gesture movement is detected using processes including electromyography (EMG), which includes analysis of electrical activity produced by skeletal muscles. Detection of gestures using wireless information requires that the wireless CSI is captured with higher fidelity. Processes to enhance the accuracy of fine gesture detection are provided. Appropriate device selection in proximity of the user is required to enhance the accuracy of the detection.

Sensor fusion i.e., combining sensor data with other forms of data, for IoT devices is provided. High quality data is identified and utilized. In some embodiments, lower layer parameters, e.g., a CSI matrix, are provided for identification of high quality data and sensor fusion. In some embodiments, higher accuracy wireless gesture detection is provided by using cooperative devices that are in a vicinity of a gesture.

### Gesture Recognition

In some gaming applications, customers using video game consoles and AR/VR headsets prefer a hands-free and natural experience compared to experiences with handheld controllers. In addition, some customers prefer to use gesture recognition without restrictions such as playing boundaries including a requirement for the user to be within a certain proximity to gesture recognition sensors.

Gesture recognition is provided with an imaging sensor such as a camera. In some embodiments, the camera is used in conjunction with mechanical, magnetic, electromagnetic, and/or ultrasonic sensors. In addition, gesture recognition is provided for consumers to communicate intent for home automation and IoT applications. In some embodiments, gesture recognition is provided as an alternative to audio-based (e.g., voice-based) control. In addition to providing gesture recognition in a home or enterprise application, gesture recognition is provided in automotive applications.

Wireless processes for gesture detection are provided that simplify the use of sensors and allow for a wider playing field compared to traditional sensors like a camera. Wireless gesture detection is also more efficient in terms of electrical power and computational power consumption than camera-based gesture detection. Relatively efficient wireless gesture detection is provided for battery-powered devices, including portable, lightweight AR headsets.

Using wireless CSI for detecting gestures reduces privacy issues compared to camera-based systems. Wireless CSI is performed, in some embodiments, without a need for visual images and recordings of a user. Wireless gesture detection is provided, in some embodiments, when a user is not within a field of view of a camera.

Gesture detection using collaborative communication between devices capable of wireless communication in a vicinity of a primary wireless communication device is provided. A primary device, which is referred to as a gesture detection initiator (GDI), is configured to determine a suitable device or set of devices to collaboratively measure channel parameters for inferring a user gesture with relatively high accuracy.

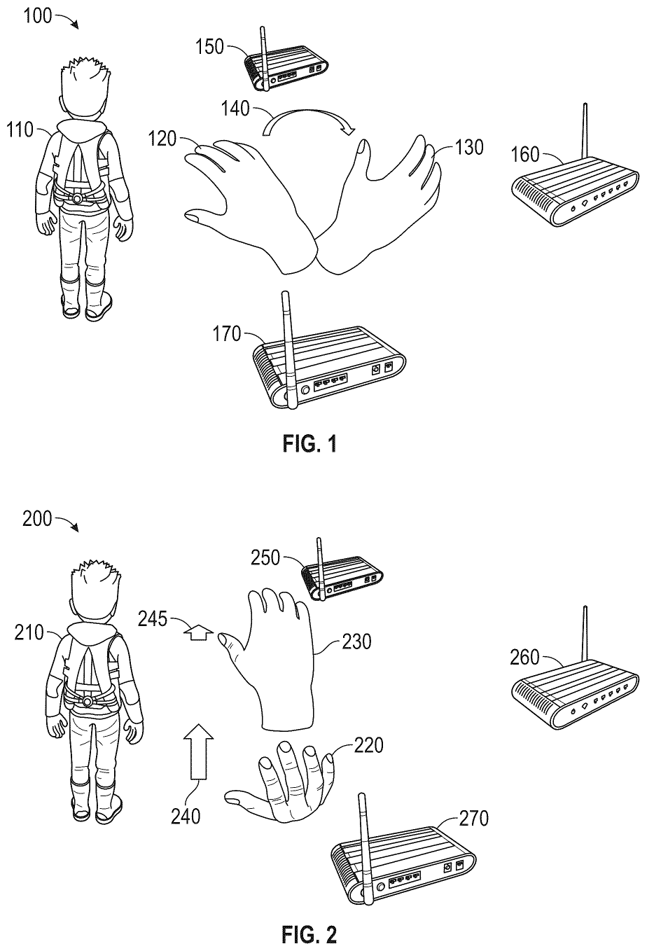

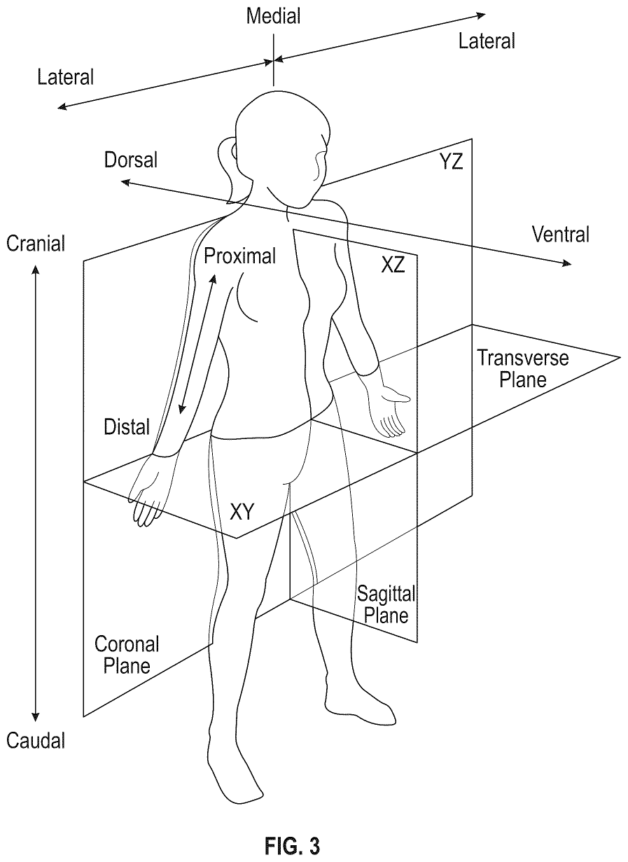

FIGS. 1 and 2 depict scenarios for gesture detection. FIG. 3 defines a reference coordinate system for features of FIGS. 1 and 2. FIG. 3 depicts a user in a reference coordinate system having an X direction extending in a dorsal direction and a ventral direction with respect to the user, a Y direction extending in lateral directions with respect to the user, and a Z direction extending in a cranial direction and a caudal direction with respect to the user. The Y direction is also referred to as a medial direction with respect to the user. A distal direction extends away from the medial direction of the user, and a proximal direction extends towards the medial direction of the user. The distal and proximal directions tend to reference arm and hand movements (as illustrated), but also reference leg and foot movements or movements of other body parts, in some embodiments. The X direction and Y direction define a transverse plane. The Y direction and the Z direction define a coronal plane. The X direction and the Z direction define a sagittal plane.

In a first scenario 100 depicted in FIG. 1, a user 110 faces into the page. A right hand of the user 110 is depicted in a first position 120 and a second position 130. In this example, the user 110 is making a “waving” motion with the right hand. The waving motion substantially occurs in the coronal plane. A motion direction 140 of the right hand of the user 110 is substantially semi-circular (with an arm of the user pivoting about an elbow of the user 110). The motion direction 140 also substantially occurs in the coronal plane. A first wireless communication device 150 is located in front of the right hand of the user 110 at a first distance in the ventral direction from the user 110. A second wireless communication device 160 is located to the right of the right hand of the user 110 at a second distance in the right-hand lateral direction from the user 110. A third wireless communication device 170 is located in back of the right hand of the user 110 at a third distance in the dorsal direction from the user 110.

In this example involving the waving motion, a higher number of orthogonal transmit-receive paths are detected by the first wireless communication device 150 and the third wireless communication device 170 as compared to the second wireless communication device 160. That is, since the waving motion substantially occurs in the coronal plane, the devices located orthogonal to the coronal plane have the higher number of orthogonal transmit-receive paths. In other words, the waving motion disrupts the signals from the first wireless communication device 150 and the third wireless communication device 170 more than those of the second wireless communication device 160.

Please note, in FIG. 2, like references with like descriptions as compared to those of FIG. 1 are denoted with identical icons and with identical penultimate digits of the reference number. That is, for example, each of reference numbers 110 and 210 denotes an object (e.g., a user). Descriptions of like references are, in some instances, described once and subsequently omitted for brevity.

In a second scenario 200 depicted in FIG. 2, the right hand of the user 210 is depicted in a first position 220 and a second position 230. In this example, the user 210 is making a “high five” motion with the right hand. The high five motion substantially occurs in the sagittal plane. An initial motion direction 240 of the right hand of the user 210 is initially substantially vertical in the cranial direction. As the right hand of the user 210 pivots about the elbow of the user 210, a subsequent motion direction 245 of the right hand of the user transitions from initially substantially vertical in the cranial direction to substantially horizontal in the ventral direction, and the right hand of the user moves so as to be substantially vertical in the cranial direction.

In this example involving the high five motion, a higher number of orthogonal transmit-receive paths are detected by the second wireless communication device 260 as compared to the first wireless communication device 250 and the third wireless communication device 270. That is, since the high five motion substantially occurs in the sagittal plane, the devices located orthogonal to the sagittal plane have the higher number of orthogonal transmit-receive paths. In other words, the high five motion disrupts the signals from the second wireless communication device 260 more than those of the first wireless communication device 250 and the third wireless communication device 270.

In another scenario (not shown), where a user performs a “no-go” or “decline” motion substantially in the transverse plane, a wireless communication device positioned relatively high (close to the ceiling) or relatively low (close to the floor) would detect a higher number of orthogonal transmit-receive paths compared to devices positioned in substantially the same transverse plane as the no-go or decline motion.

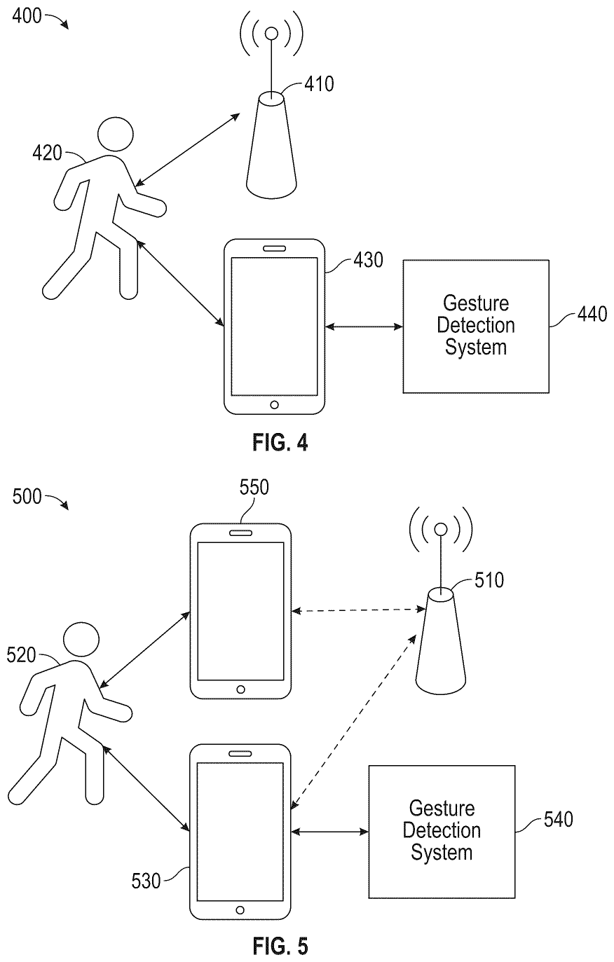

FIG. 4 depicts a wireless gesture detection system 400 according to some embodiments. Gesture detection is achieved by capturing wireless parameters of a communication channel between a transmitter 410 and a receiver 430. The transmitter 410 and the receiver 430 are, in some embodiments, a wireless access point and a mobile device, respectively. The captured parameters are used to detect gestures by an object 420 (e.g., a user) by using a gesture detection system (GDS) 440. The communication channel includes a signal sent from the transmitter to the receiver and reflected off the object 420. The GDS 440 is, in some embodiments, configured to use wireless parameters including RSSI, CSI, Doppler effect, and/or frequency shift. Also, in some embodiments, the GDS is trained and analyzed in a cloud based on machine learning, artificial intelligence, statistics, and/or pattern matching.

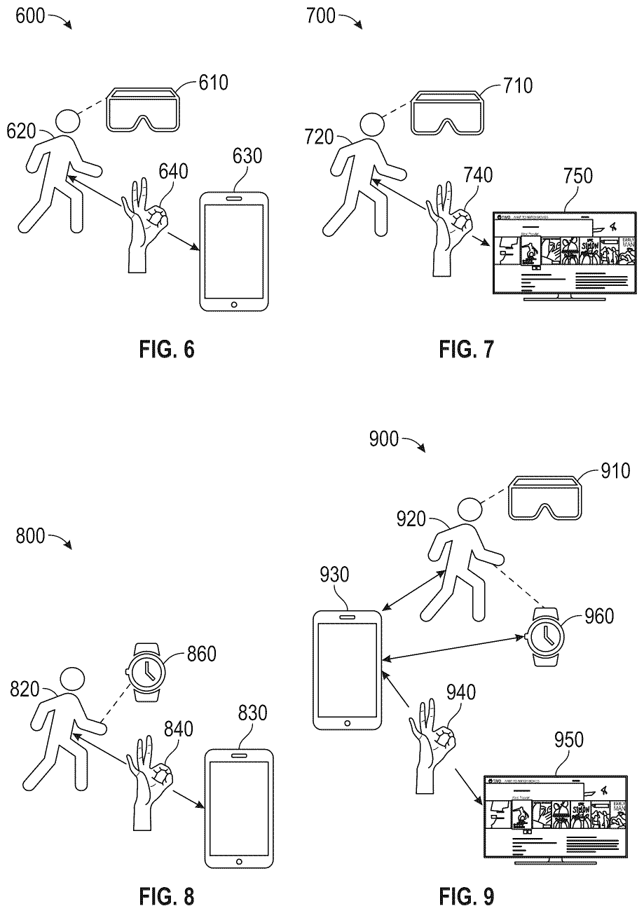

Please note, in FIGS. 5, 6, 7, 8, and 9, like references with like descriptions as compared to those of FIG. 4 are denoted with identical icons and with identical penultimate digits of the reference number. That is, for example, each of reference numbers 420, 520, 620, 720, 820, and 920 denotes an object (e.g., a user). Descriptions of like references are, in some instances, described once and subsequently omitted for brevity. Also note, in FIGS. 4-9, double-headed arrows indicate signal flow, e.g., a signal is sent from a transmitter, reflected by a user's body, for example, and received by a device. In FIG. 5, for example, dashed lines represent wireless connections between a router and a device. In FIGS. 6-9, dashed lines indicate that a device is wearable by a user. For example, the dashed line in FIG. 6 indicates that user 620 wears head mounted display (HMD) 610. The type of arrow is not intended to be limiting. For example, one or more bidirectional signal flows illustrated in the drawings are unidirectional in some embodiments; one or more unidirectional signal flows illustrated in the drawings are bidirectional in other embodiments. Other configurations of signal flow are understood.

### Gesture Detection in the Presence of Movement

Wireless CSI captured in communication between a transmitter and a receiver includes channel information that is analyzed to identify and/or determine movements. A detection of a gesture includes capturing information like Doppler shift and shadow fading (e.g., caused by a user gesture disrupting a path from the transmitter to the receiver). The Doppler shift and shadow fading are detected by amplitude changes in the wireless CSI matrix.

In the presence of movements from either the transmitter or the receiver, both the intended gesture and a confounding movement cause changes to the wireless CSI matrix. Two processes—e.g., selection of devices and/or PCA components—are provided that are used to reduce an impact of the confounding movement. Selection of peer devices is provided. The peer devices are selected, in some embodiments, based on a determination of which of a plurality of devices are not indicating a relative movement as detected by sensors. The sensors include, for example, at least one of a gyroscope, an accelerometer, or the like. A number of PCA components in the wireless CSI matrix is a variable used, in some embodiments, to enhance selection among a plurality of peer devices. The number of PCA components is used to select peer devices that currently have a higher number of orthogonal wireless paths of communication. With more orthogonal paths, relative movement and gestures are identified separately by the system. Relative movement from the transmitter and the receiver has a different signature (for example, gross movement has a different signature compared to a relatively fine hand movement) compared to the gestures detected. The additional PCA components allow for the detection of confounding movements as well as the detection of fine movement gestures. The relative movement between the transmitter and the receiver manifests differently in different orthogonal multipath signals. In some embodiments, detection of gestures in comparison to movements modeled by an artificial intelligence (AI) and/or machine learning (ML) model are provided. The AI/ML model is enhanced by incorporating confounding movement data (together with ground truth data) in a training set of gestures.

### Single P2P Connection

A P2P connection is formed between two devices in a vicinity of an object (e.g., a user). The P2P connection creates an environment where wireless gestures are detected by the peer devices. FIG. 5 illustrates a system 500 where a P2P connection is formed to enhance gesture detection. In some embodiments, the system includes a GDI that selects a peer device with compatible capability (such as a companion application or widget) for gesture detection. For example, a user 520 carrying a mobile phone 530 in their pocket forms a P2P connection with at least one additional mobile device or IoT device 550 and performs wireless communication, e.g., via a wireless transmitter 510, with the one or more peer devices 550 to aid in gesture detection. The selection of peer devices is performed, in some embodiments, by detecting a proximity to the transmitter 510. The proximity is determined, in some embodiments, based on wireless RSSI-based measurements between devices. Some embodiments of the P2P process for gesture detection are described next.

As illustrated in FIG. 6, a gesture detection system 600 is provided using a P2P connection between a gesture input device 610, such as an AR/VR headset, and a personal area network (PAN) device 630, such as a wearable or mobile phone. In this embodiment, an object 620, such as a user, is wearing device 610, i.e., the AR/VR headset. A gesture detection system is configured to detect a gesture 640 (e.g., an OK symbol formed by a user's hand) of the user wearing the AR/VR headset. In some embodiments, the device 610 maintains a backhaul connection with a router and/or a base station (in outdoor use) for communication. In some embodiments, the backhaul connection is maintained by the device 610 while simultaneously forming a P2P connection with the PAN device 630 for gesture detection. In some embodiments, the P2P connection between the device 610 (e.g., AR/VR headset) and the PAN device 630 is maintained using Bluetooth, Bluetooth Low Energy (BLE), ultra-wideband (UWB), a Wi-Fi P2P connection, and the like. In some embodiments, the backhaul connection is provided via the device 410 of FIG. 4 or the device 510 of FIG. 5.

As shown in FIG. 7, a gesture detection system 700 is provided. In the system 700, a P2P connection is provided between a gesture input device 710, such as an AR/VR headset, and a nearby static IoT device 750, such as a television or monitor. In some embodiments, to perform user gesture detection, the AR/VR headset is configured to form a P2P connection to the static device 750 or to other devices like a plug-in casting device for streaming audiovisual content. For an embodiment with application inside an automobile, a wireless access point is configured to function as an initiator device, and the initiator is configured to choose another device such as a smartphone or a smartwatch for performing gesture detection. For automotive embodiments, the gesture input system includes at least one of the infotainment system, a seat control system, another non-mission-critical control within the automobile, or the like.

In some embodiments, the P2P connection for gesture detection between the device 710 (e.g., AR/VR headset) and the static device 750 is maintained using Bluetooth, Bluetooth Low Energy (BLE), ultra-wideband (UWB), a Wi-Fi P2P connection, and the like. The device 710 maintains a simultaneous wireless local area network (LAN) backhaul for connectivity. In embodiments where the device 710 is mobile and the device 750 is static, a proximity-based connection and service discovery between devices is performed, for example, through Neighbor Awareness Networking (NAN) or a similar protocol. Such protocols are extended with a gesture detection service and associated messaging in accordance with the methods, systems, and functionality of the present disclosure.

As shown in FIG. 8, a gesture detection system 800 is provided. In the system 800, a P2P connection between two or more PAN devices is provided. In some embodiments, a P2P connection is formed between a first PAN device 830 (e.g., a smartphone) and a second PAN device 860 (e.g., a smartwatch). In embodiments using the smartwatch, the gesture 840 directly impacts a communication path between the smartwatch and the receiving device. In addition, gross movement of the smartwatch exhibits movements similar to gross hand movements. The gross hand movements are used, in some embodiments, to reduce an impact of movement on gesture detection. For example, a user's smartwatch forms a P2P connection with the user's smartphone over a Bluetooth communication system for gesture detection. Such embodiments utilizing a smartwatch and a smartphone are provided for smart home control, where the user activates a home automation “scene” using a gesture (in the context of home automation, a scene is a collection of particular states of various objects that, in combination, result in execution of an automation). A gesture detection service is provided to set up peers (such as a dedicated application for gesture detection with access to Bluetooth drivers).

### Multiple Connections for Joint Gesture Detection

As shown in FIG. 9, a gesture detection system 900 is provided. In the system 900, gesture detection processes using multiple wireless connections are provided. In some embodiments, a gesture input device or initiator device simultaneously performs gesture detection with multiple devices and uses statistical processes to improve detection accuracy. In some embodiments, a statistical process includes confidence estimates for gesture detection per receiver and estimates the gesture by adding the confidence estimates at all receivers. The GDI is configured to select one or more PAN and/or wearable devices such as an AR/VR headset 910, a smartphone 930, a smartwatch 960, a smart ring (not shown), as well as static devices such as a smart television 950 for improving the gesture estimate.

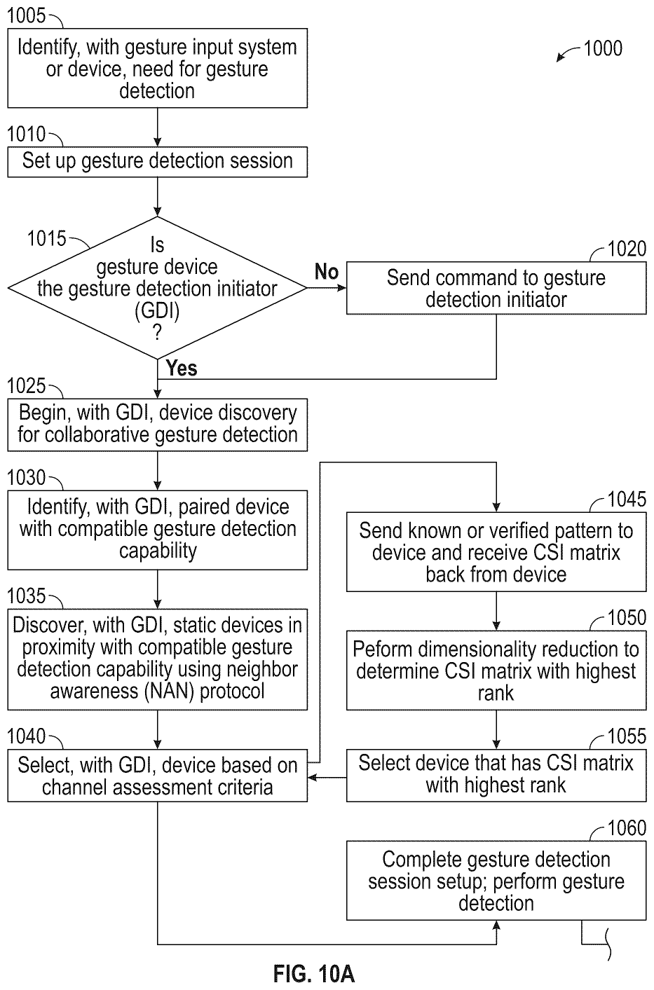

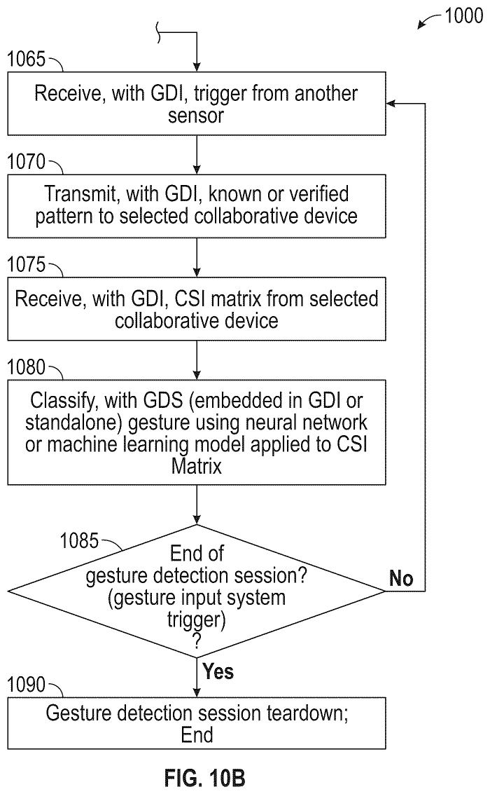

FIGS. 10A and 10B form a flowchart of a process 1000 for device selection. In some embodiments, a gesture input system is the same as the GDI. For example, a smartphone that receives a command to display email on an AR glass serves as both the gesture input system and the GDI. In some embodiments, the gesture input system and the GDI are provided separately. For example, a gesture input system (e.g., an AR/VR headset) commands another device such as a mobile phone to perform gesture detection and issues results to the mobile phone. In this embodiment, the GDI is the mobile phone, and the mobile phone collaboratively uses other devices such as a smartwatch, smart ring, and the AR/VR headset with compatible capability to perform gesture detection. Similarly, in an automotive application, a gesture input system is an infotainment system, while the GDI is a wireless device in the automobile.

The process 1000 includes at least one of steps 1005 to 1060. The process 1000 includes identifying 1005, with a gesture input system or device, a need for gesture detection. The process 1000 includes setting up 1010 a gesture detection session. The process 1000 includes a determination 1015 of whether the gesture device is the GDI. If the gesture device is the GDI (step 1015=Yes), then the process 1000 continues. If the gesture device is not the GDI (step 1015=No), then the process 1000 continues with sending 1020 a command to the GDI. The process 1000 includes beginning 1025, with the GDI, discovery for collaborative gesture detection. The process 1000 includes identifying 1030, with the GDI, one or more paired devices with compatible gesture detection capability. The process 1000 includes discovering 1035, with the GDI, one or more static devices in proximity of compatible gesture detection capability using a NAN protocol. The process 1000 includes selecting 1040, with the GDI, one or more devices based on channel assessment criteria. The channel assessment criteria includes, for example, at least one of RSSI, time of flight (ToF), angle of arrival, CSI matrix measurement, or the like. In some embodiments, the process 1000 includes a CSI matrix rank method, which includes sending 1045 a known or previously verified pattern to one or more devices and receiving the CSI matrix back from the one or more devices. The CSI matrix rank method includes performing 1050 dimensionality reduction to determine one or more CSI matrices with a highest rank or the highest ranks. The CSI matrix rank method includes selecting 1055 one or more devices that have the CSI matrix with the highest rank or the highest ranks. The process 1000 includes completing 1060 gesture detection session setup and performing gesture detection.

In some embodiments, as shown in FIG. 10B, the process 1000 continues with at least one of steps 1065 to 1090. The process 1000 includes receiving 1065, with the GDI, a trigger from another sensor. The process 1000 includes transmitting 1070, with the GDI, a known or verified pattern to a selected collaborative device. The process 1000 includes receiving 1075, with the GDI, a CSI matrix from the selected collaborative device. The process 1000 includes classifying 1080, with a GDS (either embedded in the GDI or a standalone module), a gesture using a neural network or machine learning model applied to the CSI matrix. The process 1000 includes determining 1085 whether an end of a gesture detection session has occurred. In some embodiments, the end of the gesture detection session is received from the gesture input system. In response to determining 1085 that the gesture detection session has ended (step 1085=Yes), the process 1000 includes ending 1090 the gesture detection session. In some embodiments, a teardown process occurs at the ending 1090. In response to determining 1085 that the gesture detection session has not ended (step 1085=No), the process 1000 reverts to the receiving 1065 step.

### Implementation of a Gesture Detection System (GDS) in P2P Devices

Wireless processes are provided for gesture detection using processes based on at least one of Doppler shift, frequency shift, RSSI, or CSI. In some embodiments, wireless CSI-based processes are provided. It is noted that information contained in RSSI and Doppler shift-based processes are embedded in the wireless CSI measurements. Gesture detection is provided, in some embodiments, without a need for a new or modified communication protocol. To measure CSI, a known or previously verified sequence is sent from a transmitter to a receiver. In some embodiments, a transfer function denoted by H is calculated at the receiver. A received signal Y is represented by Equation (1), as follows:

$$Y = H * X + n , \qquad ( 1 )$$

where Y is the received signal, H denotes the transfer function or CSI, X is the known or previously verified signal pattern, and * represents a convolution operation. When the received signal is impacted by noise, in some embodiments, statistical processes are implemented to reduce the noise. In some embodiments, multiple samples are collected and utilized in the calculation. In embodiments including Bluetooth and/or Wi-Fi transmission, multiple processes are provided to calculate the CSI including use of pilot carriers and use of known or previously verified data transmitted patterns to calculate CSI.

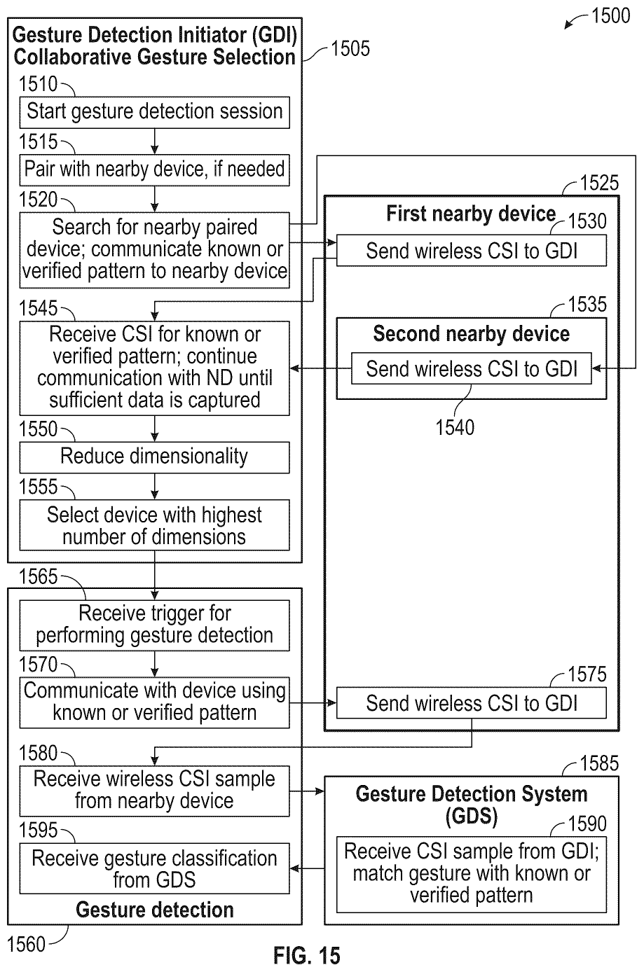

Once the CSI is determined, the CSI is sent to the GDS system for gesture detection and post-processing. A process for detecting gestures using CSI is shown in FIG. 15, described in detail herein.

In some embodiments, neighboring devices are selected and configured for gesture detection. A process for the selecting and configuring of neighboring devices includes, in some embodiments, at least one of four steps: A. Initial Paring of Devices, B. Selection of Neighboring Devices, C. Gesture Detection, or D. Always-On vs. On-Demand.

### A. Initial Pairing of Devices

A process for selection of neighboring devices to use for the gesture detection process is provided. To select the devices for gesture detection, a main device for gesture detection (e.g., the GDI) is selected. The GDI is, in some embodiments, a device that the user carries with them (e.g., a mobile phone or a smart watch) that is used to initiate the gesture detection process with one or more neighboring devices.

In some embodiments, a GDI is already paired with another PAN device and is mobile with the user. For example, a smartphone and a smartwatch are paired using Bluetooth. In an embodiment with a paired smartphone and smartwatch, compatible gesture detection capability is provided on both devices (e.g., using companion applications). With Bluetooth, in some embodiments, the neighboring devices are drawn from a list of paired or pairable devices in a user profile. In some embodiments, the GDI is paired with one or more neighboring devices using support provided by wireless technologies. With Wi-Fi, in some embodiments, the detection of neighboring devices is conducted with Wi-Fi Aware support in Android applications. With Apple applications, in some embodiments, Apple's mobile operating system, iOS, is modified to support Wi-Fi Aware or similar functionality. In some embodiments, an application or a higher layer protocol in the GDI maintains a list of devices that act or have the functionality to act as the neighboring communication device for gesture recognition.

### B. Selection of Neighboring Devices

The devices available for gesture detection will vary based on the device state and proximity. In some embodiments, some of the paired devices are turned off or are not in proximity at a given moment. GDI devices are configured to select the neighboring (paired) device for communication, and multiple processes are provided for the selection of the neighboring devices. Methods for the detection of neighboring devices include at least one of B.1. RSSI and/or ToF, B.2. Previous Detection History, or B.3. PCA Method.

B.1. RSSI and/or ToF

The GDI device, e.g., a mobile phone, a smartwatch, or an HMD, calculates the RSSI and/or ToF to a nearby device to select the device that has the highest RSSI and/or lowest ToF to the device.

When RSSI is used as a selection criterion for device selection, neighboring (paired) devices with the highest RSSI are selected for communication with the GDI device. A similar process is provided when ToF is used as the selection criterion. Also, in some embodiments, an angle of arrival is a basis for selection of the neighboring device. That is, devices are selected at different angles of arrival. In embodiments where the GDI is configured to choose multiple devices for joint gesture detection, selecting neighboring devices at different angles of arrival allows for the gesture to be estimated with greater path diversity. The greater path diversity improves gesture estimation accuracy in many implementations.

### B.2. Previous Detection History

Previous detection history and accuracy are used in some embodiments to select nearby devices. For example, when multiple devices are in the same vicinity (e.g., within a connectable distance), a device that detected gestures accurately in one or more previous sessions is used to detect gestures in a current session. In some embodiments, a user's location is determined, for example, by estimating the CSI over one or more backhaul links with one or more access points. The location is matched against a location history to choose devices that historically yielded higher accuracy gesture detection in that location.

B.3. A PCA method is provided in some embodiments for the selection of a device for the GDI to process the wireless CSI from the communication with the neighboring device to detect the rank of the CSI matrix when transmitting a known or previously verified pattern. The rank of the wireless CSI provides an estimate of the number of independent paths for communication from the transmitter to the receiver.

### PCA for Gesture Detection

In some embodiments, PCA is provided to reduce a dimensionality of data for gesture detection. That is, PCA is provided to look for one or more of the most independent devices, i.e., devices that are least affected by other devices. A CSI matrix in the context of an OFDM system is provided. A Wi-Fi system uses OFDM/OFDMA and multiple-input and multiple-output (MIMO) transmission. The CSI matrix is derived from using information about the received signal for a known or previously verified transmit signal pattern from each antenna.

In the context of wireless CSI, gestures are detected by changes in the CSI. A wireless CSI matrix that has a higher rank has multiple multi-paths between the transmitter and receiver and has a higher probability of accurately capturing the gesture information. PCA is provided in machine learning to understand the rank of the wireless CSI matrix. With PCA, a known or previously verified communication pattern is sent from the GDI to the potential neighboring devices. The received signal is decomposed into the principal components, which would account for greater than a threshold (for example, about 90%). The PCA process is repeated for each of the devices neighboring the GDI device. The neighboring devices that have the highest number of components in the PCA decomposition are shortlisted. A rank of the matrix is lower than a number of transmitting antennas times a number of receiving antennas. The rank information is used to shortlist the neighboring devices.

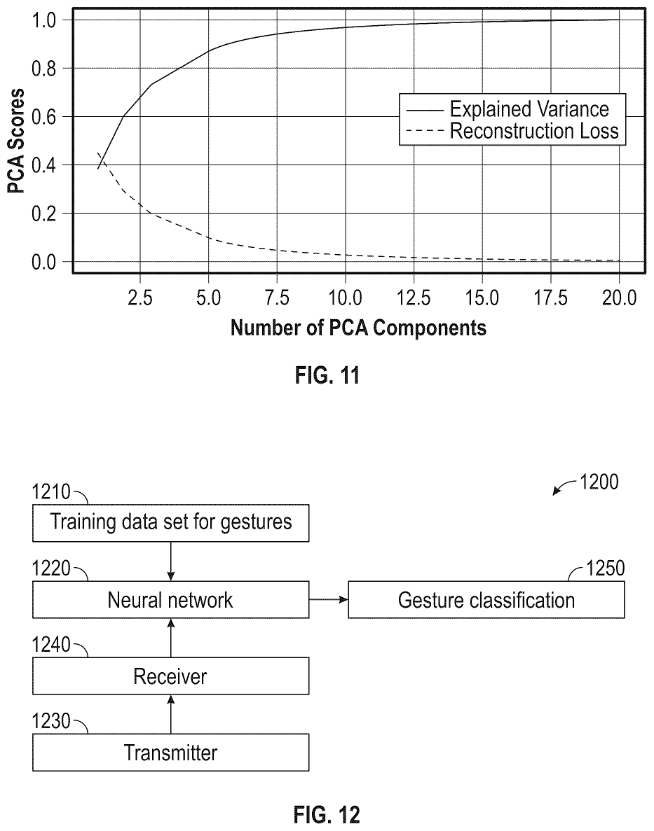

FIG. 11 depicts reconstruction loss versus a number of PCA components. Specifically, FIG. 11 illustrates an example of explained variance (solid line, upper part of FIG. 11) as a percentage of the received signal wireless CSI matrix (Y-axis) plotted against the number of PCA components (X-axis). The reconstruction loss (dashed line, lower part of FIG. 11) is data that is not explained by the selected number of PCA components. A relationship between reconstruction loss and explained variance is expressed by Equation (2), as follows:

$$Reconstruction Loss = \{ 1 - Explained Variance \} . \qquad ( 2 )$$

As seen in FIG. 11, as the number of PCA components increase, the reconstruction loss (percentage of data not explained by the PCA components) decreases. Having a higher number of PCA components indicates that there are a higher number of orthogonal transmit-receive paths. The neighbor with the highest number of dimensions to explain the received wireless CSI is determined, in some embodiments, to be the best device for collaborative gesture detection.

In some embodiments, alternate machine learning processes in dimensionality reduction are used to understand the rank of the wireless CSI matrix. For example, clustering processes including at least one of K-means, Gaussian Mixture Model (GMM) clustering, or the like, are used to understand the dimensionality reduction that matches the received data. If using the alternate machine learning processes, the neighboring device that has the highest dimensionality (that corresponds to matching a set threshold for the wireless CSI data) is shortlisted for selection.

With the shortlisted neighboring devices, a further selection of the neighboring device is required in some embodiments. Depending on the setup, the user is prompted to perform a gesture while the communication between the GDI and the shortlisted neighboring devices is ongoing. From the shortlisted devices, the neighboring devices that belong to the user's PAN, i.e., devices that are mobile with the user and have the highest accuracy for gesture detection, are selected for continuous gesture detection.

### C. Gesture Detection

Performing gesture detection with machine learning is provided. In some embodiments, a deep neural network is provided for wireless CSI measurements. A machine learning system 1200 for gesture detection is shown in FIG. 12. The system 1200 includes training a model with machine learning based on settings, embodiments, and classified gestures. In some embodiments, a model is used to pretrain the neural network before applying user specific information. During an initialization phase, the user is prompted to perform known or previously verified gestures. The initialization phase calibrates the pretrained neural network to the user specific information.

When gesture detection is triggered, wireless CSI for known or previously verified transmit patterns is captured at the receiver and sent to the GDS for gesture detection. The wireless CSI is provided in time series in some embodiments. The GDS inputs the wireless CSI matrix to trained neural networks, which classify the gesture. When the neural network or machine learning process predicts a gesture with high confidence, the classified gesture is sent to higher layer protocols for processing of the gesture (e.g., turning on a television in an IoT use case).

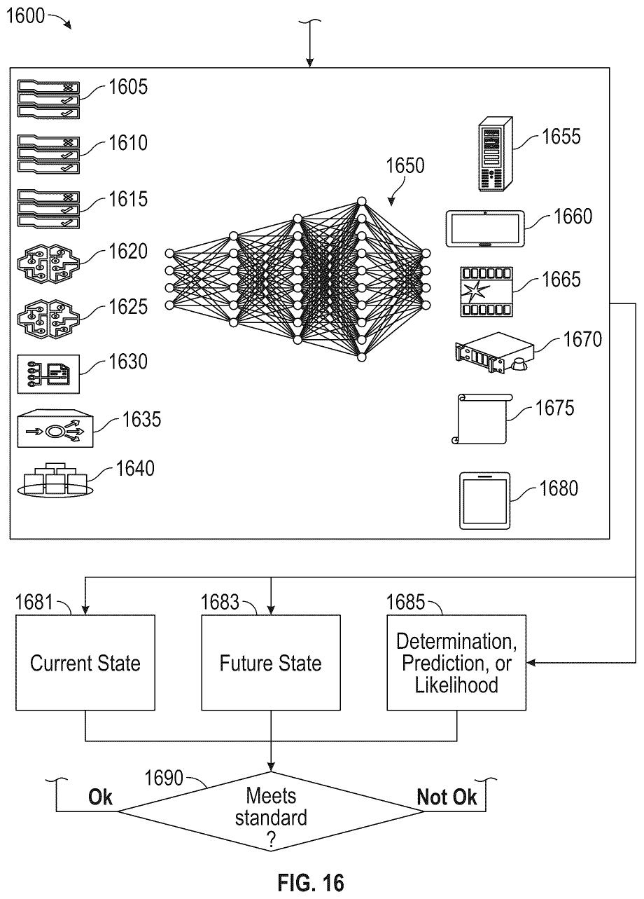

In some embodiments, the system 1200 includes at least one of a training data set 1210, a neural network 1220, a transmitter 1230, a receiver 1240, or a gesture classification module 1250. The system 1200 includes the training data set 1210 for gestures (e.g., from a wireless GDS), which are sent to the neural network 1220. The system 1200 includes sending a known or previously verified pattern from the transmitter 1230 to the receiver 1240. The system 1200 includes sending a time series of received wireless CSI from the receiver 1240 to the neural network 1220. The neural network 1220 processes the received information and sends the processed information to the gesture classification module 1250. The neural network 1220 includes, in some embodiments, the prediction process 1600 of FIG. 16.

D. Always-on Vs. On-Demand

A gesture detection session is initiated, in some embodiments, with communication between the GDI and the neighboring device in an always-on mode. In the always-on mode, when the GDI device is active, the GDI device maintains a connection with a neighboring device for gesture detection. The always-on mode includes continuous transmission of a known or previously verified sequence from the GDI to one or more collaborative devices. The always-on is relatively power-inefficient compared to the on-demand mode.

A gesture detection session is initiated, in some embodiments, with communication between the GDI and the neighboring device in an on-demand mode. In the on-demand mode, a specific trigger from a sensor (e.g., an accelerometer, a gyroscope, a motion detector, a presence detector, an image sensor, or the like) initiates gesture detection. In some embodiments, the sensor is provided on a smartwatch, a smartphone, or as part of a detector embedded in an environment. In some embodiments, gesture detection starts in response to a command to a voice assistant system that sends a message to the GDI to begin the gesture detection session.

After initiation in the on-demand mode, the GDI continues to communicate using wireless communication with a wireless router and passively observes communication from other devices to the router. When a change in wireless CSI is detected by the GDI device, the process for selection of collaborative devices is reinitiated and a new gesture detection session is set up. After the gesture detection session is set up, when a trigger for performing gesture detection is received, the GDI initiates transmission of the known or previously verified sequence.

### User Interfaces (Gesture Detection Application on a Smart Phone)

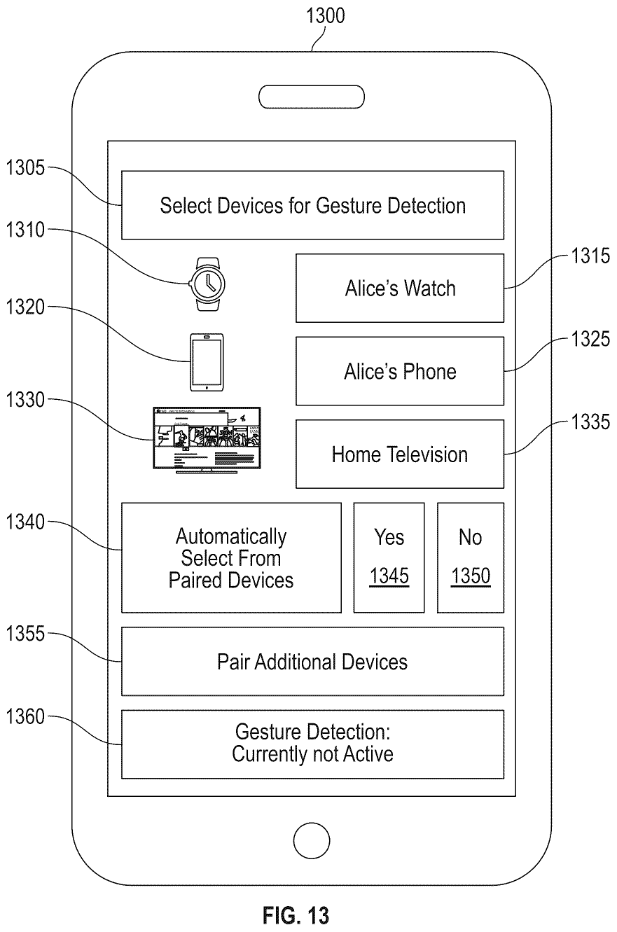

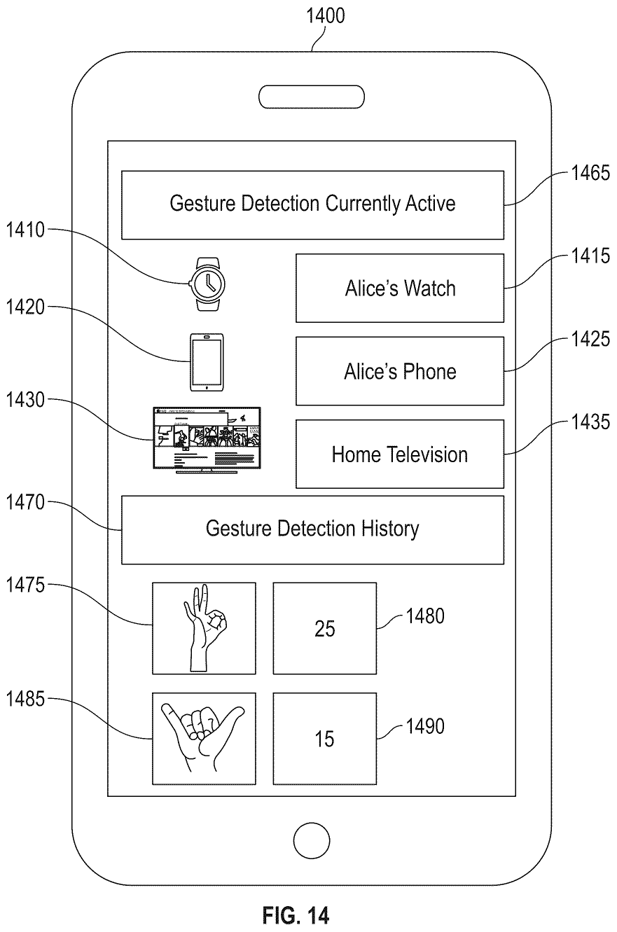

In some embodiments, the gesture detection system interfaces with an application, e.g., a smartphone application, configured with one or more user interfaces. The application provides visibility to the user, allows pairing of devices, and provides relevant information to the user. Examples of user interfaces 1300 and 1400 for pairing of devices for gesture detection and gesture detection accuracy are shown in FIGS. 13 and 14, respectively. The user interfaces 1300 and 1400 are provided for any suitable device, such as a smartphone, as illustrated. In some embodiments, the user interface 1300 includes at least one of buttons, indicators, and/or icons 1305 to 1360, and the user interface 1400 includes at least one of buttons, indicators, and/or icons 1410 to 1490. As used herein, the term “button” refers to a user selectable virtual button as provided on a touch-responsive display screen of a smartphone. In some embodiments, the button is a physical button provided on a remote control (not shown). Please note, in FIGS. 13 and 14, like references with like descriptions are denoted with identical icons and with identical penultimate digits of the reference number. Descriptions of like references are, in some instances, described once and subsequently omitted for brevity.

In some embodiments, the user interface 1300 includes a button 1305 configured to select devices for gesture detection. In response to user selection of the button 1305, one or more devices for gesture detection are identified, and appropriate buttons and/or icons are displayed. For example, a smartwatch, a smartphone, and a smart television associated with a user profile of a user of the smartphone are identified. The user interface 1300 includes a plurality of icons and buttons corresponding to the identified devices. In this example, the user interface 1300 is configured to display an icon 1310 (e.g., a watch icon) and a corresponding button 1315 identifying the device (e.g., “ALICE'S WATCH”). In response to user selection of the button 1315, gesture detection using the identified device (e.g., “ALICE'S WATCH”) is initiated. Additional devices are identified in some embodiments. In this example, the user interface 1300 is configured to display an icon 1320 (e.g., a smartphone icon) and a corresponding button 1325 identifying the device (e.g., “ALICE'S PHONE”). In response to user selection of the button 1325, gesture detection using the identified device (e.g., “ALICE'S PHONE”) is initiated. The user interface 1300 is configured to display an icon 1330 (e.g., a television icon) and a corresponding button 1335 identifying the device (e.g., “HOME TELEVISION”). In response to user selection of the button 1335, gesture detection using the identified device (e.g., “HOME TELEVISION”) is initiated. The user interface 1300 includes a prompt 1340 for automatic pairing (e.g., “AUTOMATICALLY SELECT FROM PAIRED DEVICES”). The prompt 1340 is a user selectable button in some embodiments. Alternatively, as illustrated in this example, the user interface 1300 includes an affirmative button 1345 (e.g., “YES”) and a negative button 1350 (e.g., “NO”). When the prompt 1340 is a button, in response to user selection of the button 1340 or the affirmative button 1345, gesture detection is performed automatically from the paired devices. The user interface 1300 includes a button 1355 for pairing additional devices (e.g., “PAIR ADDITIONAL DEVICES”). In response to user selection of the button 1355, steps of searching and pairing of additional devices are performed. The user interface 1300 includes a gesture detection status indicator 1360, e.g., “GESTURE DETECTION: CURRENTLY NOT ACTIVE,” which corresponds to an inactive state of the gesture detection. The gesture detection status indicator 1360 is configured to display an active state of the gesture detection, e.g., indicator 1465 (e.g., “GESTURE DETECTION CURRENTLY ACTIVE”) of FIG. 14. In some embodiments, the gesture detection status indicator 1360 is configured as a button that, upon selection, toggles the system between active and inactive states. In response to user selection of the gesture detection status indicator 1360 configured as a button, the interface 1400 is generated for display.

As shown in FIG. 14, the user interface 1400 corresponds to an active gesture detection session. In some embodiments, elements 1410 to 1435 are similar to 1310 to 1335, respectively, described above. The user interface 1400 includes a gesture detection history indicator 1470 (e.g., “GESTURE DETECTION HISTORY”). The user interface 1400 includes one or more representations of gestures and a count of a number of times each gesture has been detected. For example, as shown in FIG. 14, the user interface 1400 includes a first representation 1475 of a first gesture (e.g., the “OK” finger/hand gesture as illustrated) and a second representation 1485 of a second gesture (e.g., the “hang loose” finger/hand gesture as illustrated). The user interface 1400 includes a first count 1480 of a number (e.g., 25) of times the “OK” gesture was detected, and a second count 1490 of a number (e.g., 15) of times the “hang loose” gesture was detected.

In some embodiments, there is a process 1500 for gesture detection, which is shown in FIG. 15. The process 1500 includes at least one of a GDI collaborative gesture selection process 1505, a first nearby device (ND) 1525, a second nearby device (ND) 1535, a gesture detection process 1560, or a gesture detection system (GDS) 1585. The process 1500 includes at least one of steps 1510 to 1595. The process 1500 includes starting 1510 a gesture detection session. The process 1500 includes pairing 1515 with one or more nearby devices, if needed. The process 1500 includes searching 1520 for one or more nearby paired devices and communicating a known or previously verified pattern to the one or more nearby devices. The process 1500 includes the first ND 1525 sending 1530 wireless CSI to the GDI. The process 1500 includes the second ND 1535 sending 1540 wireless CSI to the GDI. The process 1500 includes receiving 1545 the CSI for one or more known or previously verified patterns and continuing communication with the first ND 1525 and the second ND 1535 until sufficient data is captured. In some embodiments, sufficient data corresponds with a predetermined threshold determined based on gesture accuracy required while reducing a probability of a false positive. The process 1500 includes reducing 1550 dimensionality. The process 1500 includes selecting 1555 one or more devices with a highest number of dimensions. The process 1500 includes receiving 1565 a trigger for performing gesture detection. The process 1500 includes communicating 1570 with one or more devices using one or more known or previously verified patterns. The process 1500 includes the first ND 1525 sending 1575 wireless CSI to the GDI. The process 1500 includes receiving 1580 one or more wireless CSI samples from one or more nearby devices. The process 1500 includes the GDS 1585 receiving 1590 one or more CSI samples from the GDI and matching a gesture with one or more known or previously verified patterns. The matching of the receiving 1590 is performed, in some embodiments, using machine learning, statistical techniques, and/or pattern recognition. The process 1500 includes receiving 1595 gesture classification from the GDS.

### Predictive Model

Throughout the present disclosure, in some embodiments, determinations, predictions, likelihoods, and the like are determined with one or more predictive models. For example, FIG. 16 depicts a predictive model. A prediction process 1600 includes a predictive model 1650 in some embodiments. The predictive model 1650 receives as input various forms of data about one, more or all the users, media content items, devices, and data described in the present disclosure. The predictive model 1650 performs analysis based on at least one of hard rules, learning rules, hard models, learning models, usage data, load data, analytics of the same, metadata, or profile information, and the like. The predictive model 1650 outputs one or more predictions of a future state of any of the devices described in the present disclosure. A load-increasing event is determined by load-balancing processes, e.g., least connection, least bandwidth, round robin, server response time, weighted versions of the same, resource-based processes, and address hashing. The predictive model 1650 is based on input including at least one of a hard rule 1605, a user-defined rule 1610, a rule defined by a content provider 1615, a hard model 1620, or a learning model 1625.

The predictive model 1650 receives as input usage data 1630. The predictive model 1650 is based, in some embodiments, on at least one of a usage pattern of the user or media device, a usage pattern of the requesting media device, a usage pattern of the media content item, a usage pattern of the communication system or network, a usage pattern of the profile, or a usage pattern of the media device.

The predictive model 1650 receives as input load-balancing data 1635. The predictive model 1650 is based on at least one of load data of the display device, load data of the requesting media device, load data of the media content item, load data of the communication system or network, load data of the profile, or load data of the media device.

The predictive model 1650 receives as input metadata 1640. The predictive model 1650 is based on at least one of metadata of the streaming service, metadata of the requesting media device, metadata of the media content item, metadata of the communication system or network, metadata of the profile, or metadata of the media device. The metadata includes information of the type represented in the media device manifest.

The predictive model 1650 is trained with data. The training data is developed in some embodiments using one or more data processes including but not limited to data selection, data sourcing, and data synthesis. The predictive model 1650 is trained in some embodiments with one or more analytical processes including but not limited to classification and regression trees (CART), discrete choice models, linear regression models, logistic regression, logit versus probit, multinomial logistic regression, multivariate adaptive regression splines, probit regression, regression processes, survival or duration analysis, and time series models. The predictive model 1650 is trained in some embodiments with one or more machine learning approaches including but not limited to supervised learning, unsupervised learning, semi-supervised learning, reinforcement learning, and dimensionality reduction. The predictive model 1650 in some embodiments includes regression analysis including analysis of variance (ANOVA), linear regression, logistic regression, ridge regression, and/or time series. The predictive model 1650 in some embodiments includes classification analysis including decision trees and/or neural networks. In FIG. 16, a depiction of a multi-layer neural network is provided as a non-limiting example of a predictive model 1650, the neural network including an input layer (left side), three hidden layers (middle), and an output layer (right side) with 32 neurons and 192 edges, which is intended to be illustrative, not limiting. The predictive model 1650 is based on data engineering and/or modeling processes. The data engineering processes include exploration, cleaning, normalizing, feature engineering, and scaling. The modeling processes include model selection, training, evaluation, and tuning. The predictive model 1650 is operationalized using registration, deployment, monitoring, and/or retraining processes.

The predictive model 1640 is configured to output results to a device or multiple devices. The device includes means for performing one, more, or all the features referenced herein of the methods, processes, and outputs of one or more of FIGS. 1, 2, 4-10, and 12-15, in any suitable combination. The device is at least one of a server 1655, a tablet 1660, a media display device 1665, a network-connected computer 1670, a media device 1675, a computing device 1680, or the like.

The predictive model 1650 is configured to output a current state 1681, and/or a future state 1683, and/or a determination, a prediction, or a likelihood 1685, and the like. The current state 1681, and/or the future state 1683, and/or the determination, the prediction, or the likelihood 1685, and the like are compared 1690 to a predetermined or determined standard. In some embodiments, the standard is satisfied (1490=OK) or rejected (1490=NOT OK). If the standard is satisfied or rejected, the predictive process 1600 outputs at least one of the current state, the future state, the determination, the prediction, or the likelihood to any device or module disclosed herein.

### Communication System

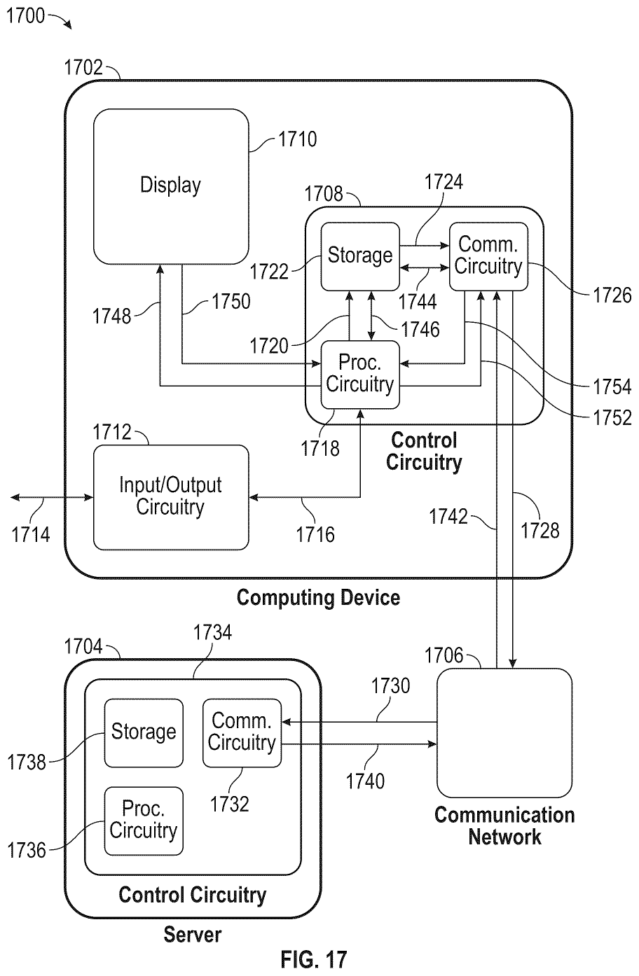

FIG. 17 depicts a block diagram of system 1700, in accordance with some embodiments. The system is shown to include computing device 1702, server 1704, and a communication network 1706. It is understood that while a single instance of a component may be shown and described relative to FIG. 17, additional embodiments of the component may be employed. For example, server 1704 may include, or may be incorporated in, more than one server. Similarly, communication network 1706 may include, or may be incorporated in, more than one communication network. Server 1704 is shown communicatively coupled to computing device 1702 through communication network 1706. While not shown in FIG. 17, server 1704 may be directly communicatively coupled to computing device 1702, for example, in a system absent or bypassing communication network 1706.

Communication network 1706 may include one or more network systems, such as, without limitation, the Internet, LAN, Wi-Fi, wireless, or other network systems suitable for audio processing applications. The system 1700 of FIG. 17 excludes server 1704, and functionality that would otherwise be implemented by server 1704 is instead implemented by other components of the system depicted by FIG. 17, such as one or more components of communication network 1706. In still other embodiments, server 1704 works in conjunction with one or more components of communication network 1706 to implement certain functionality described herein in a distributed or cooperative manner. Similarly, the system depicted by FIG. 17 excludes computing device 1702, and functionality that would otherwise be implemented by computing device 1702 is instead implemented by other components of the system depicted by FIG. 17, such as one or more components of communication network 1706 or server 1704 or a combination of the same. In other embodiments, computing device 1702 works in conjunction with one or more components of communication network 1706 or server 1704 to implement certain functionality described herein in a distributed or cooperative manner.

Computing device 1702 includes control circuitry 1708, display 1710 and input/output (I/O) circuitry 1712. Control circuitry 1708 may be based on any suitable processing circuitry and includes control circuits and memory circuits, which may be disposed on a single integrated circuit or may be discrete components. As referred to herein, processing circuitry should be understood to mean circuitry based on at least one microprocessors, microcontrollers, digital signal processors, programmable logic devices, field-programmable gate arrays (FPGAs), or application-specific integrated circuits (ASICs), and the like, and may include a multi-core processor (e.g., dual-core, quad-core, hexa-core, or any suitable number of cores). In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). Some control circuits may be implemented in hardware, firmware, or software. Control circuitry 1708 in turn includes communication circuitry 1726, storage 1722 and processing circuitry 1718. Either of control circuitry 1708 and 1734 may be utilized to execute or perform any or all the methods, processes, and outputs of one or more of FIGS. 1, 2, 4-10, and 12-16, or any combination of steps thereof (e.g., as enabled by processing circuitries 1718 and 1736, respectively).

In addition to control circuitry 1708 and 1734, computing device 1702 and server 1704 may each include storage (storage 1722, and storage 1738, respectively). Each of storages 1722 and 1738 may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 8D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each of storage 1722 and 1738 may be used to store several types of content, metadata, and/or other types of data. Non-volatile memory may also be used (e.g., to launch a boot-up routine and other instructions). Cloud-based storage may be used to supplement storages 1722 and 1738 or instead of storages 1722 and 1738. In some embodiments, a user profile and messages corresponding to a chain of communication may be stored in one or more of storages 1722 and 1738. Each of storages 1722 and 1738 may be utilized to store commands, for example, such that when each of processing circuitries 1718 and 1736, respectively, are prompted through control circuitries 1708 and 1734, respectively. Either of processing circuitries 1718 or 1736 may execute any of the methods, processes, and outputs of one or more of FIGS. 1, 2, 4-10, and 12-16, or any combination of steps thereof.

In some embodiments, control circuitry 1708 and/or 1734 executes instructions for an application stored in memory (e.g., storage 1722 and/or storage 1738). Specifically, control circuitry 1708 and/or 1734 may be instructed by the application to perform the functions discussed herein. In some embodiments, any action performed by control circuitry 1708 and/or 1734 may be based on instructions received from the application. For example, the application may be implemented as software or a set of and/or one or more executable instructions that may be stored in storage 1722 and/or 1738 and executed by control circuitry 1708 and/or 1734. The application may be a client/server application where only a client application resides on computing device 1702, and a server application resides on server 1704.

The application may be implemented using any suitable architecture. For example, it may be a stand-alone application wholly implemented on computing device 1702. In such an approach, instructions for the application are stored locally (e.g., in storage 1722), and data for use by the application is downloaded on a periodic basis (e.g., from an out-of-band feed, from an Internet resource, or using another suitable approach). Control circuitry 1708 may retrieve instructions for the application from storage 1722 and process the instructions to perform the functionality described herein. Based on the processed instructions, control circuitry 1708 may determine a type of action to perform in response to input received from I/O circuitry 1712 or from communication network 1706.

In client/server-based embodiments, control circuitry 1708 may include communication circuitry suitable for communicating with an application server (e.g., server 1704) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the Internet or any other suitable communication networks or paths (e.g., communication network 1706). In another example of a client/server-based application, control circuitry 1708 runs a web browser that interprets web pages provided by a remote server (e.g., server 1704). For example, the remote server may store the instructions for the application in a storage device.

The remote server may process the stored instructions using circuitry (e.g., control circuitry 1734) and/or generate displays. Computing device 1702 may receive the displays generated by the remote server and may display the content of the displays locally via display 1710. For example, display 1710 may be utilized to present a string of characters. This way, the processing of the instructions is performed remotely (e.g., by server 1704) while the resulting displays, such as the display windows described elsewhere herein, are provided locally on computing device 1704. Computing device 1702 may receive inputs from the user via input/output circuitry 1712 and transmit those inputs to the remote server for processing and generating the corresponding displays.

Alternatively, computing device 1702 may receive inputs from the user via input/output circuitry 1712 and process and display the received inputs locally, by control circuitry 1708 and display 1710, respectively. For example, input/output circuitry 1712 may correspond to a keyboard and/or a set of and/or one or more speakers/microphones which are used to receive user inputs (e.g., input as displayed in a search bar or a display of FIG. 17 on a computing device). Input/output circuitry 1712 may also correspond to a communication link between display 1710 and control circuitry 1708 such that display 1710 updates in response to inputs received via input/output circuitry 1712 (e.g., simultaneously update what is shown in display 1710 based on inputs received by generating corresponding outputs based on instructions stored in memory via a non-transitory, computer-readable medium).

Server 1704 and computing device 1702 may transmit and receive content and data such as media content via communication network 1706. For example, server 1704 may be a media content provider, and computing device 1702 may be a smart television configured to download or stream media content, such as a live news broadcast, from server 1704. Control circuitry 1734, 1708 may send and receive commands, requests, and other suitable data through communication network 1706 using communication circuitry 1732, 1726, respectively. Alternatively, control circuitry 1734, 1708 may communicate directly with each other using communication circuitry 1732, 1726, respectively, avoiding communication network 1706.

It is understood that computing device 1702 is not limited to the embodiments and methods shown and described herein. In nonlimiting examples, computing device 1702 may be a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a handheld computer, a stationary telephone, a personal digital assistant (PDA), a mobile telephone, a portable video player, a portable music player, a portable gaming machine, a smartphone, or any other device, computing equipment, or wireless device, and/or combination of the same, capable of suitably displaying and manipulating media content.

Computing device 1702 receives user input 1714 at input/output circuitry 1712. For example, computing device 1702 may receive a user input such as a user swipe or user touch. It is understood that computing device 1702 is not limited to the embodiments and methods shown and described herein.

User input 1714 may be received from a user selection-capturing interface that is separate from device 1702, such as a remote-control device, trackpad, or any other suitable user movement-sensitive, audio-sensitive or capture devices, or as part of device 1702, such as a touchscreen of display 1710. Transmission of user input 1714 to computing device 1702 may be accomplished using a wired connection, such as an audio cable, universal serial bus (USB) cable, ethernet cable and the like attached to a corresponding input port at a local device, or may be accomplished using a wireless connection, such as Bluetooth, Wi-Fi, WiMAX, GSM, UTMS, CDMA, TDMA, 8G, 4G, 4G LTE, 5G, or any other suitable wireless transmission protocol. Input/output circuitry 1712 may include a physical input port such as a 12.5 mm (0.4921 inch) audio jack, RCA audio jack, USB port, ethernet port, or any other suitable connection for receiving audio over a wired connection or may include a wireless receiver configured to receive data via Bluetooth, Wi-Fi, WiMAX, GSM, UTMS, CDMA, TDMA, 3G, 4G, 4G LTE, 5G, or other wireless transmission protocols.

Processing circuitry 1718 may receive user input 1714 from input/output circuitry 1712 using communication path 1716. Processing circuitry 1718 may convert or translate the received user input 1714 that may be in the form of audio data, visual data, gestures, or movement to digital signals. In some embodiments, input/output circuitry 1712 performs the translation to digital signals. In some embodiments, processing circuitry 1718 (or processing circuitry 1736, as the case may be) carries out disclosed processes and methods.

Processing circuitry 1718 may provide requests to storage 1722 by communication path 1720. Storage 1722 may provide requested information to processing circuitry 1718 by communication path 1746. Storage 1722 may transfer a request for information to communication circuitry 1726 which may translate or encode the request for information to a format receivable by communication network 1706 before transferring the request for information by communication path 1728. Communication network 1706 may forward the translated or encoded request for information to communication circuitry 1732, by communication path 1730.

At communication circuitry 1732, the translated or encoded request for information, received through communication path 1730, is translated or decoded for processing circuitry 1736, which will provide a response to the request for information based on information available through control circuitry 1734 or storage 1738, or a combination thereof. The response to the request for information is then provided back to communication network 1706 by communication path 1740 in an encoded or translated format such that communication network 1706 forwards the encoded or translated response back to communication circuitry 1726 by communication path 1742.

At communication circuitry 1726, the encoded or translated response to the request for information may be provided directly back to processing circuitry 1718 by communication path 1754 or may be provided to storage 1722 through communication path 1744, which then provides the information to processing circuitry 1718 by communication path 1746. Processing circuitry 1718 may also provide a request for information directly to communication circuitry 1726 through communication path 1752, where storage 1722 responds to an information request (provided through communication path 1720 or 1744) by communication path 1724 or 1746 that storage 1722 does not contain information pertaining to the request from processing circuitry 1718.

Processing circuitry 1718 may process the response to the request received through communication paths 1746 or 1754 and may provide instructions to display 1710 for a notification to be provided to the users through communication path 1748. Display 1710 may incorporate a timer for providing the notification or may rely on inputs through input/output circuitry 1712 from the user, which are forwarded through processing circuitry 1718 through communication path 1748, to determine how long or in what format to provide the notification. When display 1710 determines the display has been completed, a notification may be provided to processing circuitry 1718 through communication path 1750.

The communication paths provided in FIG. 17 between computing device 1702, server 1704, communication network 1706, and all subcomponents depicted are examples and may be modified to reduce processing time or enhance processing capabilities for each step in the processes disclosed herein by one skilled in the art.

### INCORPORATIONS BY REFERENCE

In some embodiments, one or more features of U.S. patent application Ser. Nos. 17/481,931 and 17/481,955, titled, “Systems and Methods for Controlling Media Content Based on User Presence,” filed Sep. 22, 2021, and published Mar. 23, 2023, as U.S. Patent Application Publication Nos. 2023/0087963 and 2023/0091437, respectively, to Doken, et al., which are hereby incorporated by reference herein in their entireties, are provided. Also, in some embodiments, one or more features of U.S. patent application Ser. No. 17/882,793, titled, “Systems and Methods for Detecting Unauthorized Broadband Internet Access Sharing,” filed Aug. 8, 2022, to Doken, et al., which is hereby incorporated by reference herein in its entirety, are provided. Further, in some embodiments, one or more features of U.S. patent application Ser. No. 18/088,134, titled, “User Authentication Based on Wireless Signal Detection in a Head Mounted Device,” filed Dec. 22, 2022, to Koshy, which is hereby incorporated by reference herein in its entirety, are provided. Still further, in some embodiments, one or more features of U.S. patent application Ser. No. 18/135,582, titled, “Methods and Systems for Sharing Private Data,” filed Apr. 17, 2023, to Singh, et al., which is hereby incorporated by reference herein in its entirety, are provided.

### Terminology

The terminology used herein is for the purpose of describing particular embodiments only and is not intended to be limiting of the disclosure.

Throughout the present disclosure, the term “XR” includes without limitation extended reality (XR), augmented reality (AR), 3D content, 4D experiences, next-gen UIs, virtual reality (VR), mixed reality (MR) experiences, interactive experiences, a combination of the same, and the like.

As used herein, the terms “real time,” “simultaneous,” “substantially on-demand,” and the like are understood to be nearly instantaneous and include delay due to practical limits of the system in some embodiments. Such delays are on the order of milliseconds or microseconds, depending on the application and nature of the processing. Relatively longer delays (e.g., greater than a millisecond) result due to communication or processing delays, particularly in remote and cloud computing environments.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Although at least one embodiment is described as using a plurality of units or modules to perform a process or processes, it is understood that the process or processes are performed by one or a plurality of units or modules. Additionally, it is understood that the term controller/control unit refers, in some embodiments, to a hardware device that includes a memory and a processor. The memory is configured to store the units or the modules, and the processor is specifically configured to execute said units or modules to perform one or more processes which are described herein.

Unless specifically stated or obvious from context, as used herein, the term “about” is understood as within a range of normal tolerance in the art, for example within 2 standard deviations of the mean. “About” is understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The use of the terms “first”, “second”, “third”, and so on, herein, are provided to identify structures or operations, without describing an order of structures or operations, and, to the extent the structures or operations are used in an embodiment, the structures are provided or the operations are executed in a different order from the stated order unless a specific order is definitely specified in the context.

The methods and/or any instructions for performing any of the embodiments discussed herein are encoded on computer-readable media, in some embodiments. Computer-readable media includes any media capable of storing data. The computer-readable media are transitory, including, but not limited to, propagating electrical or electromagnetic signals, or are non-transitory (e.g., a non-transitory, computer-readable medium accessible by an application via control or processing circuitry from storage) including, but not limited to, volatile and non-volatile computer memory or storage devices such as a hard disk, floppy disk, USB drive, DVD, CD, media cards, register memory, processor caches, random access memory (RAM), and the like.

The interfaces, processes, and analysis described may, in some embodiments, be performed by an application. The application is loaded directly onto each device of any of the systems described or is stored in a remote server or any memory and processing circuitry accessible to each device in the system. The generation of interfaces and analysis there-behind is performed at a receiving device, a sending device, or some device or processor therebetween.

The systems and processes discussed herein are intended to be illustrative and not limiting. One skilled in the art would appreciate that the actions of the processes discussed herein are, in some embodiments, omitted, modified, combined, and/or rearranged, and any additional actions are performed without departing from the scope of the invention. More generally, the disclosure herein is meant to provide examples and is not limiting. Only the claims that follow are meant to set bounds as to what the present disclosure includes. Furthermore, it should be noted that the features and limitations described in any one embodiment are applied to any other embodiment herein, and flowcharts or examples relating to one embodiment are combined with any other embodiment in a suitable manner, done in different orders, or done in parallel. In addition, the methods and systems described herein are be performed in real time. It should also be noted that the methods and/or systems described herein are applied to, or used in accordance with, other methods and/or systems.

This specification discloses embodiments, which include, but are not limited to, the following items:

Item 1. A method comprising:
identifying a plurality of network devices within a range of a user performing a gesture;
selecting a subset of the plurality of network devices based on a relative direction of each network device of the plurality of network devices to the user and a directionality of the gesture;
and performing an operation for detecting the gesture using the selected subset of the plurality of network devices.

Item 2. The method of item 1, wherein the selecting the subset of the plurality of network devices based on the relative direction of each network device of the plurality of network devices to the user and the directionality of the gesture comprises:
ranking each of the plurality of network devices; and
selecting the subset of the plurality of network devices based on the ranking.

Item 3. The method of item 2, wherein the ranking of each of the plurality of network devices is based on a number of independent paths for each of the plurality of network devices.

Item 4. The method of item 2, wherein the ranking of each of the plurality of network devices is based on a channel state information (CSI) indicator matrix for each of the plurality of network devices.

Item 5. The method of item 4, wherein the ranking of each of the plurality of network devices is based on a principal components analysis of the CSI indicator matrix for each of the plurality of network devices.

Item 6. The method of item 5, wherein the ranking of each of the plurality of network devices is based on the principal components analysis of the CSI indicator matrix for each of the plurality of network devices, and the principal components analysis identifies a number of orthogonal wireless paths of communications for each of the plurality of network devices, and

wherein a higher number of orthogonal wireless paths of communications for each of the plurality of network devices correlates with a higher ranking.

Item 7. The method of item 1, wherein the selecting the subset of the plurality of network devices based on the relative direction of each network device of the plurality of network devices to the user and the directionality of the gesture comprises:
in response to the gesture predominantly occurring in a transverse plane of a body of the user, selecting the subset of devices of the plurality of network devices oriented perpendicularly to the transverse plane;
in response to the gesture predominantly occurring in a coronal plane of the body of the user, selecting the subset of devices of the plurality of network devices oriented perpendicularly to the coronal plane; and
in response to the gesture predominantly occurring in a sagittal plane of a body of the user, selecting the subset of devices of the plurality of network devices oriented perpendicularly to the sagittal plane.

Item 8. The method of item 1, wherein the selecting the subset of the plurality of network devices based on the relative direction of each network device of the plurality of network devices to the user and the directionality of the gesture comprises:
prompting the user to perform the gesture; and
testing each of the plurality of network devices.

Item 9. The method of item 8, wherein the testing of each of the plurality of network devices comprises testing at least one of a received signal strength indicator (RSSI), a channel state information (CSI) indicator, a Doppler effect, or a frequency shift of each of the plurality of network devices.

Item 10. The method of item 9, wherein the testing of each of the plurality of network devices comprises testing each of the RSSI, the CSI indicator, the Doppler effect, and the frequency shift of each of the plurality of network devices.

Item 11. The method of item 8, comprising:
generating channel data for each of the plurality of network devices based on the testing,
wherein the selecting the subset of the plurality of network devices based on the relative direction of each network device of the plurality of network devices to the user and the directionality of the gesture comprises:
selecting the subset of the plurality of network devices based on the generated channel data.

Item 12. The method of item 11, wherein the generating of the channel data for each of the identified devices tested with the wireless parameter includes reducing a dimensionality of the channel data.

Item 13. The method of item 11, wherein the selecting the subset of the plurality of network devices based on the generated channel data is based on determining the channel data with a highest associated dimensionality.

Item 14. The method of item 11, wherein the selecting the subset of the plurality of network devices is based on determining a device associated with the generated channel data most affected by a gesture.

Item 15. The method of item 1, wherein the identifying the plurality of network devices within the range of the user performing the gesture includes filtering the identified devices based on a proximity to the transmitter.

Item 16. The method of item 1, wherein the identifying the plurality of network devices within the range of the user performing the gesture includes filtering the identified devices based on a strength of a signal.

Item 17. The method of item 1, comprising:
initiating a gesture detection session;
wherein the identifying the plurality of network devices within the range of a user performing the gesture comprises identifying a paired device or pairing with a nearby device;
transmitting, from a transmitter of the plurality of network devices, a known pattern to the paired device;
receiving, at the paired device, the known pattern and transmitting a first response to the transmitter;
determining, at the transmitter, a first wireless parameter based on the response;
determining whether the wireless parameter meets a predetermined threshold;
reducing a dimensionality of the wireless parameter;
wherein the selecting the subset of the plurality of network devices based on the relative direction of each network device of the plurality of network devices to the user and the directionality of the gesture comprises selecting a device for gesture detection based on the wireless parameter having the reduced dimensionality;
receiving, at the transmitter, a trigger for the gesture detection;
transmitting the known pattern to the selected device;
receiving, at the selected device, the known pattern and transmitting a first response to the transmitter;
determining, at the transmitter, a second wireless parameter based on the second response;
transmitting the second wireless parameter to a gesture detection system;
wherein the performing the operation for detecting the gesture using the selected subset of the plurality of network devices comprises determining, with the gesture detection system, an identification of a gesture based on a comparison of the second wireless pattern with a database of known gestures and known wireless parameters; and
receiving, at the transmitter, the identification of the gesture.

Item 18. The method of item 1, wherein the gesture is a hand gesture.

Item 19. The method of item 1, wherein the gesture is a finger gesture.

Item 20. The method of item 1, wherein the gesture is a hand gesture and a finger gesture.

Item 21. A system comprising:
circuitry configured to:
   identify a plurality of network devices within a range of a user performing a gesture;
   select a subset of the plurality of network devices based on a relative direction of each network device of the plurality of network devices to the user and a directionality of the gesture; and
   perform an operation for detecting the gesture using the selected subset of the plurality of network devices.

Item 22. The system of item 21, wherein the circuitry configured to select the subset of the plurality of network devices based on the relative direction of each network device of the plurality of network devices to the user and the directionality of the gesture is configured to:
rank each of the plurality of network devices; and
select the subset of the plurality of network devices based on the ranking.

Item 23. The system of item 22, wherein the circuitry configured to rank each of the plurality of network devices is based on a number of independent paths for each of the plurality of network devices.

Item 24. The system of item 22, wherein the circuitry configured to rank each of the plurality of network devices is based on a channel state information (CSI) indicator matrix for each of the plurality of network devices.

Item 25. The system of item 24, wherein the circuitry configured to rank each of the plurality of network devices is based on a principal components analysis of the CSI indicator matrix for each of the plurality of network devices.

Item 26. The system of item 25, wherein the circuitry configured to rank each of the plurality of network devices is based on the principal components analysis of the CSI indicator matrix for each of the plurality of network devices, and the principal components analysis identifies a number of orthogonal wireless paths of communications for each of the plurality of network devices, and wherein a higher number of orthogonal wireless paths of communications for each of the plurality of network devices correlates with a higher ranking.

Item 27. The system of item 21, wherein the circuitry configured to select the subset of the plurality of network devices based on the relative direction of each network device of the plurality of network devices to the user and the directionality of the gesture is configured to:
in response to the gesture predominantly occurring in a transverse plane of a body of the user, select the subset of devices of the plurality of network devices oriented perpendicularly to the transverse plane;
in response to the gesture predominantly occurring in a coronal plane of the body of the user, select the subset of devices of the plurality of network devices oriented perpendicularly to the coronal plane; and
in response to the gesture predominantly occurring in a sagittal plane of a body of the user, select the subset of devices of the plurality of network devices oriented perpendicularly to the sagittal plane.

Item 28. The system of item 21, wherein the circuitry configured to select the subset of the plurality of network devices based on the relative direction of each network device of the plurality of network devices to the user and the directionality of the gesture is configured to:
prompt the user to perform the gesture; and
test each of the plurality of network devices.

Item 29. The system of item 28, wherein the circuitry configured to test each of the plurality of network devices is configured to test at least one of a received signal strength indicator (RSSI), a channel state information (CSI) indicator, a Doppler effect, or a frequency shift of each of the plurality of network devices.

Item 30. The system of item 29, wherein the circuitry configured to test each of the plurality of network devices is configured to test each of the RSSI, the CSI indicator, the Doppler effect, and the frequency shift of each of the plurality of network devices.

Item 31. The system of item 28, wherein the circuitry is configured to:
generate channel data for each of the plurality of network devices based on the testing,
wherein the circuitry configured to select the subset of the plurality of network devices based on the relative direction of each network device of the plurality of network devices to the user and the directionality of the gesture is configured to:
select the subset of the plurality of network devices based on the generated channel data.

Item 32. The system of item 31, wherein the circuitry configured to generate the channel data for each of the identified devices tested with the wireless parameter is configured to reduce a dimensionality of the channel data.

Item 33. The system of item 31, wherein the circuitry configured to select the subset of the plurality of network devices based on the generated channel data is further based on determining the channel data with a highest associated dimensionality.

Item 34. The system of item 31, wherein the circuitry configured to select the subset of the plurality of network devices is further based on determining a device associated with the generated channel data most affected by a gesture.

Item 35. The system of item 21, wherein the circuitry configured to identify the plurality of network devices within the range of the user performing the gesture is configured to filter the identified devices based on a proximity to the transmitter.

Item 36. The system of item 21, wherein the circuitry configured to identify the plurality of network devices within the range of the user performing the gesture is configured to filter the identified devices based on a strength of a signal.

Item 37. The system of item 21, wherein the circuitry is configured to:
initiate a gesture detection session;
wherein the circuitry configured to identify the plurality of network devices within the range of a user performing the gesture is configured to identify a paired device or pair with a nearby device;
transmit, from a transmitter of the plurality of network devices, a known pattern to the paired device;
receive, at the paired device, the known pattern and transmit a first response to the transmitter;
determine, at the transmitter, a first wireless parameter based on the response;
determine whether the wireless parameter meets a predetermined threshold;
reduce a dimensionality of the wireless parameter;
wherein the circuitry configured to select the subset of the plurality of network devices based on the relative direction of each network device of the plurality of network devices to the user and the directionality of the gesture is configured to select a device for gesture detection based on the wireless parameter having the reduced dimensionality;
receive, at the transmitter, a trigger for the gesture detection;
transmit the known pattern to the selected device;
receive, at the selected device, the known pattern and transmit a first response to the transmitter;
determine, at the transmitter, a second wireless parameter based on the second response;
transmit the second wireless parameter to a gesture detection system;
wherein the circuitry configured to perform the operation for detecting the gesture using the selected subset of the plurality of network devices is configured to determine, with the gesture detection system, an identification of a gesture based on a comparison of the second wireless pattern with a database of known gestures and known wireless parameters; and
receive, at the transmitter, the identification of the gesture.

Item 38. The system of item 21, wherein the gesture is a hand gesture.

Item 39. The system of item 21, wherein the gesture is a finger gesture.

Item 40. The system of item 21, wherein the gesture is a hand gesture and a finger gesture.

Item 41. A device configured to:
identify a plurality of network devices within a range of a user performing a gesture;
select a subset of the plurality of network devices based on a relative direction of each network device of the plurality of network devices to the user and a directionality of the gesture; and
perform an operation for detecting the gesture using the selected subset of the plurality of network devices.

Item 42. The device of item 41, wherein the device configured to select the subset of the plurality of network devices is configured to select the subset of the plurality of network devices based on the relative direction of each network device of the plurality of network devices to the user and the directionality of the gesture is configured to:
rank each of the plurality of network devices; and
select the subset of the plurality of network devices based on the ranking.

Item 43. The device of item 42, wherein the device configured to rank each of the plurality of network devices is configured to rank each of the plurality of network devices based on a number of independent paths for each of the plurality of network devices.

Item 44. The device of item 42, wherein the device configured to rank each of the plurality of network devices is configured to rank each of the plurality of network devices based on a channel state information (CSI) indicator matrix for each of the plurality of network devices.

Item 45. The device of item 44, wherein the device configured to rank each of the plurality of network devices is configured to rank each of the plurality of network devices based on a principal components analysis of the CSI indicator matrix for each of the plurality of network devices.

Item 46. The device of item 45, wherein the device configured to rank each of the plurality of network devices is configured to rank each of the plurality of network devices based on the principal components analysis of the CSI indicator matrix for each of the plurality of network devices, and the principal components analysis identifies a number of orthogonal wireless paths of communications for each of the plurality of network devices, and wherein a higher number of orthogonal wireless paths of communications for each of the plurality of network devices correlates with a higher ranking.

Item 47. The device of item 41, wherein the device configured to select the subset of the plurality of network devices is configured to select the subset of the plurality of network devices based on the relative direction of each network device of the plurality of network devices to the user and the directionality of the gesture is configured to:
in response to the gesture predominantly occurring in a transverse plane of a body of the user, select the subset of devices of the plurality of network devices oriented perpendicularly to the transverse plane;
in response to the gesture predominantly occurring in a coronal plane of the body of the user, select the subset of devices of the plurality of network devices oriented perpendicularly to the coronal plane; and
in response to the gesture predominantly occurring in a sagittal plane of a body of the user, select the subset of devices of the plurality of network devices oriented perpendicularly to the sagittal plane.

Item 48. The device of item 41, wherein the device configured to select the subset of the plurality of network devices is configured to select the subset of the plurality of network devices based on the relative direction of each network device of the plurality of network devices to the user and the directionality of the gesture is configured to:
prompt the user to perform the gesture; and
test each of the plurality of network devices.

Item 49. The device of item 48, wherein the device configured to test each of the plurality of network devices is configured to test at least one of a received signal strength indicator (RSSI), a channel state information (CSI) indicator, a Doppler effect, or a frequency shift of each of the plurality of network devices.

Item 50. The device of item 49, wherein the device configured to test each of the plurality of network devices is configured to test each of the RSSI, the CSI indicator, the Doppler effect, and the frequency shift of each of the plurality of network devices.

Item 51. The device of item 48, wherein the device is configured to:
generate channel data for each of the plurality of network devices based on the testing,
wherein the device configured to select the subset of the plurality of network devices is configured to select the subset of the plurality of network devices based on the relative direction of each network device of the plurality of network devices to the user and the directionality of the gesture is configured to:
select the subset of the plurality of network devices based on the generated channel data.

Item 52. The device of item 31, wherein the device configured to generate the channel data for each of the identified devices tested with the wireless parameter is configured to reduce a dimensionality of the channel data.

Item 53. The device of item 31, wherein the device configured to select the subset of the plurality of network devices is configured to select the subset of the plurality of network devices based on the generated channel data is based on determining the channel data with a highest associated dimensionality.

Item 54. The device of item 31, wherein the device configured to select the subset of the plurality of network devices is configured to select the subset of the plurality of network devices is based on determining a device associated with the generated channel data most affected by a gesture.

Item 55. The device of item 41, wherein the device configured to identify the plurality of network devices within the range of the user performing the gesture is configured to filter the identified devices based on a proximity to the transmitter.

Item 56. The device of item 41, wherein the device configured to identify the plurality of network devices within the range of the user performing the gesture is configured to filter the identified devices based on a strength of a signal.

Item 57. The device of item 41, wherein the device is configured to:
initiate a gesture detection session;
wherein the device configured to identify the plurality of network devices within the range of a user performing the gesture is configured to identify a paired device or pair with a nearby device;
transmit, from a transmitter of the plurality of network devices, a known pattern to the paired device;
receive, at the paired device, the known pattern and transmit a first response to the transmitter;
determine, at the transmitter, a first wireless parameter based on the response;
determine whether the wireless parameter meets a predetermined threshold;
reduce a dimensionality of the wireless parameter;
wherein the device configured to select the subset of the plurality of network devices is configured to select the subset of the plurality of network devices based on the relative direction of each network device of the plurality of network devices to the user and the directionality of the gesture is configured to select a device for gesture detection based on the wireless parameter having the reduced dimensionality;
receive, at the transmitter, a trigger for the gesture detection;
transmit the known pattern to the selected device;
receive, at the selected device, the known pattern and transmit a first response to the transmitter;
determine, at the transmitter, a second wireless parameter based on the second response;
transmit the second wireless parameter to a gesture detection device;
wherein the device configured to perform the operation for detecting the gesture using the selected subset of the plurality of network devices is configured to determine, with the gesture detection device, an identification of a gesture based on a comparison of the second wireless pattern with a database of known gestures and known wireless parameters; and
receive, at the transmitter, the identification of the gesture.

Item 58. The device of item 41, wherein the gesture is a hand gesture.

Item 59. The device of item 41, wherein the gesture is a finger gesture.

Item 60. The device of item 41, wherein the gesture is a hand gesture and a finger gesture.

Item 61. A device comprising:
means for identifying a plurality of network devices within a range of a user performing a gesture;
means for selecting a subset of the plurality of network devices based on a relative direction of each network device of the plurality of network devices to the user and a directionality of the gesture; and
means for performing an operation for detecting the gesture using the selected subset of the plurality of network devices.

Item 62. The device of item 61, wherein the means for selecting the subset of the plurality of network devices based on the relative direction of each network device of the plurality of network devices to the user and the directionality of the gesture comprises:
means for ranking each of the plurality of network devices; and
means for selecting the subset of the plurality of network devices based on the ranking.

Item 63. The device of item 62, wherein the means for ranking of each of the plurality of network devices is based on a number of independent paths for each of the plurality of network devices.

Item 64. The device of item 62, wherein the means for ranking of each of the plurality of network devices is based on a channel state information (CSI) indicator matrix for each of the plurality of network devices.

Item 65. The device of item 64, wherein the means for ranking of each of the plurality of network devices is based on a principal components analysis of the CSI indicator matrix for each of the plurality of network devices.

Item 66. The device of item 65, wherein the means for ranking of each of the plurality of network devices is based on the principal components analysis of the CSI indicator matrix for each of the plurality of network devices, and the principal components analysis identifies a number of orthogonal wireless paths of communications for each of the plurality of network devices, and wherein a higher number of orthogonal wireless paths of communications for each of the plurality of network devices correlates with a higher ranking.

Item 67. The device of item 61, wherein the means for selecting the subset of the plurality of network devices based on the relative direction of each network device of the plurality of network devices to the user and the directionality of the gesture comprises:
in response to the gesture predominantly occurring in a transverse plane of a body of the user, means for selecting the subset of devices of the plurality of network devices oriented perpendicularly to the transverse plane;
in response to the gesture predominantly occurring in a coronal plane of the body of the user, means for selecting the subset of devices of the plurality of network devices oriented perpendicularly to the coronal plane; and
in response to the gesture predominantly occurring in a sagittal plane of a body of the user, means for selecting the subset of devices of the plurality of network devices oriented perpendicularly to the sagittal plane.

Item 68. The device of item 61, wherein the means for selecting the subset of the plurality of network devices based on the relative direction of each network device of the plurality of network devices to the user and the directionality of the gesture comprises:
means for prompting the user to perform the gesture; and
means for testing each of the plurality of network devices.

Item 69. The device of item 68, wherein the means for testing of each of the plurality of network devices comprises means for testing at least one of a received signal strength indicator (RSSI), a channel state information (CSI) indicator, a Doppler effect, or a frequency shift of each of the plurality of network devices.

Item 70. The device of item 69, wherein the means for testing of each of the plurality of network devices comprises means for testing each of the RSSI, the CSI indicator, the Doppler effect, and the frequency shift of each of the plurality of network devices.

Item 71. The device of item 68, comprising:
means for generating channel data for each of the plurality of network devices based on the testing,
wherein the means for selecting the subset of the plurality of network devices based on the relative direction of each network device of the plurality of network devices to the user and the directionality of the gesture comprises:
means for selecting the subset of the plurality of network devices based on the generated channel data.

Item 72. The device of item 71, wherein the means for generating of the channel data for each of the identified devices tested with the wireless parameter includes means for reducing a dimensionality of the channel data.

Item 73. The device of item 71, wherein the means for selecting the subset of the plurality of network devices based on the generated channel data is based on means for determining the channel data with a highest associated dimensionality.

Item 74. The device of item 71, wherein the means for selecting the subset of the plurality of network devices is based on means for determining a device associated with the generated channel data most affected by a gesture.

Item 75. The device of item 61, wherein the means for identifying the plurality of network devices within the range of the user performing the gesture includes means for filtering the identified devices based on a proximity to the transmitter.

Item 76. The device of item 61, wherein the means for identifying the plurality of network devices within the range of the user performing the gesture includes means for filtering the identified devices based on a strength of a signal.

Item 77. The device of item 61, comprising:
means for initiating a gesture detection session;
wherein the means for identifying the plurality of network devices within the range of a user performing the gesture comprises means for identifying a paired device or pairing with a nearby device;
means for transmitting, from a transmitter of the plurality of network devices, a known pattern to the paired device;
means for receiving, at the paired device, the known pattern and transmitting a first response to the transmitter;
means for determining, at the transmitter, a first wireless parameter based on the response;
means for determining whether the wireless parameter meets a predetermined threshold;
means for reducing a dimensionality of the wireless parameter;
wherein the means for selecting the subset of the plurality of network devices based on the relative direction of each network device of the plurality of network devices to the user and the directionality of the gesture comprises means for selecting a device for gesture detection based on the wireless parameter having the reduced dimensionality;
means for receiving, at the transmitter, a trigger for the gesture detection;
means for transmitting the known pattern to the selected device;
means for receiving, at the selected device, the known pattern and transmitting a first response to the transmitter;
means for determining, at the transmitter, a second wireless parameter based on the second response;
means for transmitting the second wireless parameter to a gesture detection system;
wherein the means for performing the operation for detecting the gesture using the selected subset of the plurality of network devices comprises means for determining, with the gesture detection system, an identification of a gesture based on a comparison of the second wireless pattern with a database of known gestures and known wireless parameters; and
means for receiving, at the transmitter, the identification of the gesture.

Item 78. The device of item 61, wherein the gesture is a hand gesture.

Item 79. The device of item 61, wherein the gesture is a finger gesture.

Item 80. The device of item 61, wherein the gesture is a hand gesture and a finger gesture.

Item 81. A non-transitory, computer-readable medium having non-transitory, computer-readable instructions encoded thereon, that, when executed, perform:
identifying a plurality of network devices within a range of a user performing a gesture;
selecting a subset of the plurality of network devices based on a relative direction of each network device of the plurality of network devices to the user and a directionality of the gesture; and
performing an operation for detecting the gesture using the selected subset of the plurality of network devices.

Item 82. The non-transitory, computer-readable medium of item 81, wherein the selecting the subset of the plurality of network devices based on the relative direction of each network device of the plurality of network devices to the user and the directionality of the gesture comprises:
ranking each of the plurality of network devices; and
selecting the subset of the plurality of network devices based on the ranking.

Item 83. The non-transitory, computer-readable medium of item 82, wherein the ranking of each of the plurality of network devices is based on a number of independent paths for each of the plurality of network devices.

Item 84. The non-transitory, computer-readable medium of item 82, wherein the ranking of each of the plurality of network devices is based on a channel state information (CSI) indicator matrix for each of the plurality of network devices.

Item 85. The non-transitory, computer-readable medium of item 84, wherein the ranking of each of the plurality of network devices is based on a principal components analysis of the CSI indicator matrix for each of the plurality of network devices.

Item 86. The non-transitory, computer-readable medium of item 85, wherein the ranking of each of the plurality of network devices is based on the principal components analysis of the CSI indicator matrix for each of the plurality of network devices, and the principal components analysis identifies a number of orthogonal wireless paths of communications for each of the plurality of network devices, and wherein a higher number of orthogonal wireless paths of communications for each of the plurality of network devices correlates with a higher ranking.

Item 87. The non-transitory, computer-readable medium of item 81, wherein the selecting the subset of the plurality of network devices based on the relative direction of each network device of the plurality of network devices to the user and the directionality of the gesture comprises:
in response to the gesture predominantly occurring in a transverse plane of a body of the user, selecting the subset of devices of the plurality of network devices oriented perpendicularly to the transverse plane;
in response to the gesture predominantly occurring in a coronal plane of the body of the user, selecting the subset of devices of the plurality of network devices oriented perpendicularly to the coronal plane; and
in response to the gesture predominantly occurring in a sagittal plane of a body of the user, selecting the subset of devices of the plurality of network devices oriented perpendicularly to the sagittal plane.

Item 88. The non-transitory, computer-readable medium of item 81, wherein the selecting the subset of the plurality of network devices based on the relative direction of each network device of the plurality of network devices to the user and the directionality of the gesture comprises:
prompting the user to perform the gesture; and
testing each of the plurality of network devices.

Item 89. The non-transitory, computer-readable medium of item 88, wherein the testing of each of the plurality of network devices comprises testing at least one of a received signal strength indicator (RSSI), a channel state information (CSI) indicator, a Doppler effect, or a frequency shift of each of the plurality of network devices.

Item 90. The non-transitory, computer-readable medium of item 89, wherein the testing of each of the plurality of network devices comprises testing each of the RSSI, the CSI indicator, the Doppler effect, and the frequency shift of each of the plurality of network devices.

Item 91. The non-transitory, computer-readable medium of item 88, comprising:
generating channel data for each of the plurality of network devices based on the testing,
wherein the selecting the subset of the plurality of network devices based on the relative direction of each network device of the plurality of network devices to the user and the directionality of the gesture comprises:
selecting the subset of the plurality of network devices based on the generated channel data.

Item 92. The non-transitory, computer-readable medium of item 91, wherein the generating of the channel data for each of the identified devices tested with the wireless parameter includes reducing a dimensionality of the channel data.

Item 93. The non-transitory, computer-readable medium of item 91, wherein the selecting the subset of the plurality of network devices based on the generated channel data is based on determining the channel data with a highest associated dimensionality.

Item 94. The non-transitory, computer-readable medium of item 91, wherein the selecting the subset of the plurality of network devices is based on determining a device associated with the generated channel data most affected by a gesture.

Item 95. The non-transitory, computer-readable medium of item 81, wherein the identifying the plurality of network devices within the range of the user performing the gesture includes filtering the identified devices based on a proximity to the transmitter.

Item 96. The non-transitory, computer-readable medium of item 81, wherein the identifying the plurality of network devices within the range of the user performing the gesture includes filtering the identified devices based on a strength of a signal.

Item 97. The non-transitory, computer-readable medium of item 81, comprising:
initiating a gesture detection session;
wherein the identifying the plurality of network devices within the range of a user performing the gesture comprises identifying a paired device or pairing with a nearby device;
transmitting, from a transmitter of the plurality of network devices, a known pattern to the paired device;
receiving, at the paired device, the known pattern and transmitting a first response to the transmitter;
determining, at the transmitter, a first wireless parameter based on the response;
determining whether the wireless parameter meets a predetermined threshold;
reducing a dimensionality of the wireless parameter;
wherein the selecting the subset of the plurality of network devices based on the relative direction of each network device of the plurality of network devices to the user and the directionality of the gesture comprises selecting a device for gesture detection based on the wireless parameter having the reduced dimensionality;
receiving, at the transmitter, a trigger for the gesture detection;
transmitting the known pattern to the selected device;
receiving, at the selected device, the known pattern and transmitting a first response to the transmitter;
determining, at the transmitter, a second wireless parameter based on the second response;
transmitting the second wireless parameter to a gesture detection system;
wherein the performing the operation for detecting the gesture using the selected subset of the plurality of network devices comprises determining, with the gesture detection system, an identification of a gesture based on a comparison of the second wireless pattern with a database of known gestures and known wireless parameters; and
receiving, at the transmitter, the identification of the gesture.

Item 98. The non-transitory, computer-readable medium of item 81, wherein the gesture is a hand gesture.

Item 99. The non-transitory, computer-readable medium of item 81, wherein the gesture is a finger gesture.

Item 100. The non-transitory, computer-readable medium of item 81, wherein the gesture is a hand gesture and a finger gesture.

This description is to be taken only by way of example and not to otherwise limit the scope of the embodiments herein. Therefore, it is the object of the appended claims to cover all such variations and modifications as come within the true spirit and scope of the embodiments herein.

1. A method comprising:
identifying a plurality of network devices within a range of a user performing a gesture;
selecting a subset of the plurality of network devices based on a relative direction of each network device of the plurality of network devices to the user and a directionality of the gesture; and
performing an operation for detecting the gesture using the selected subset of the plurality of network devices.

2. The method of claim 1, wherein the selecting the subset of the plurality of network devices based on the relative direction of each network device of the plurality of network devices to the user and the directionality of the gesture comprises:
ranking each of the plurality of network devices; and
selecting the subset of the plurality of network devices based on the ranking.

3. The method of claim 2, wherein the ranking of each of the plurality of network devices is based on a number of independent paths for each of the plurality of network devices.

4. The method of claim 2, wherein the ranking of each of the plurality of network devices is based on a channel state information (CSI) indicator matrix for each of the plurality of network devices.

5. The method of claim 4, wherein the ranking of each of the plurality of network devices is based on a principal components analysis of the CSI indicator matrix for each of the plurality of network devices.

6. The method of claim 5, wherein the ranking of each of the plurality of network devices is based on the principal components analysis of the CSI indicator matrix for each of the plurality of network devices, and the principal components analysis identifies a number of orthogonal wireless paths of communications for each of the plurality of network devices, and wherein a higher number of orthogonal wireless paths of communications for each of the plurality of network devices correlates with a higher ranking.

7. The method of claim 1, wherein the selecting the subset of the plurality of network devices based on the relative direction of each network device of the plurality of network devices to the user and the directionality of the gesture comprises:
in response to the gesture predominantly occurring in a transverse plane of a body of the user, selecting the subset of devices of the plurality of network devices oriented perpendicularly to the transverse plane;
in response to the gesture predominantly occurring in a coronal plane of the body of the user, selecting the subset of devices of the plurality of network devices oriented perpendicularly to the coronal plane; and
in response to the gesture predominantly occurring in a sagittal plane of a body of the user, selecting the subset of devices of the plurality of network devices oriented perpendicularly to the sagittal plane.

8. The method of claim 1, wherein the selecting the subset of the plurality of network devices based on the relative direction of each network device of the plurality of network devices to the user and the directionality of the gesture comprises:
prompting the user to perform the gesture; and
testing each of the plurality of network devices.

9. The method of claim 8, wherein the testing of each of the plurality of network devices comprises testing at least one of a received signal strength indicator (RSSI), a channel state information (CSI) indicator, a Doppler effect, or a frequency shift of each of the plurality of network devices.

10. The method of claim 9, wherein the testing of each of the plurality of network devices comprises testing each of the RSSI, the CSI indicator, the Doppler effect, and the frequency shift of each of the plurality of network devices.

11. The method of claim 8, comprising:
generating channel data for each of the plurality of network devices based on the testing,
wherein the selecting the subset of the plurality of network devices based on the relative direction of each network device of the plurality of network devices to the user and the directionality of the gesture comprises:
selecting the subset of the plurality of network devices based on the generated channel data.

12. The method of claim 11, wherein the generating of the channel data for each of the identified devices tested with the wireless parameter includes reducing a dimensionality of the channel data.

13. The method of claim 11, wherein the selecting the subset of the plurality of network devices based on the generated channel data is based on determining the channel data with a highest associated dimensionality.

14. The method of claim 11, wherein the selecting the subset of the plurality of network devices is based on determining a device associated with the generated channel data most affected by a gesture.

15. The method of claim 1, wherein the identifying the plurality of network devices within the range of the user performing the gesture includes filtering the identified devices based on a proximity to the transmitter.

16. The method of claim 1, wherein the identifying the plurality of network devices within the range of the user performing the gesture includes filtering the identified devices based on a strength of a signal.

17. The method of claim 1, comprising:
initiating a gesture detection session;
wherein the identifying the plurality of network devices within the range of a user performing the gesture comprises identifying a paired device or pairing with a nearby device;
transmitting, from a transmitter of the plurality of network devices, a known pattern to the paired device;
receiving, at the paired device, the known pattern and transmitting a first response to the transmitter;
determining, at the transmitter, a first wireless parameter based on the response;
determining whether the wireless parameter meets a predetermined threshold;
reducing a dimensionality of the wireless parameter;
wherein the selecting the subset of the plurality of network devices based on the relative direction of each network device of the plurality of network devices to the user and the directionality of the gesture comprises selecting a device for gesture detection based on the wireless parameter having the reduced dimensionality;
receiving, at the transmitter, a trigger for the gesture detection;
transmitting the known pattern to the selected device;
receiving, at the selected device, the known pattern and transmitting a first response to the transmitter;
determining, at the transmitter, a second wireless parameter based on the second response;
transmitting the second wireless parameter to a gesture detection system;
wherein the performing the operation for detecting the gesture using the selected subset of the plurality of network devices comprises determining, with the gesture detection system, an identification of a gesture based on a comparison of the second wireless pattern with a database of known gestures and known wireless parameters; and
receiving, at the transmitter, the identification of the gesture.

18.-20. (canceled)

21. A system comprising:
circuitry configured to:
identify a plurality of network devices within a range of a user performing a gesture;
select a subset of the plurality of network devices based on a relative direction of each network device of the plurality of network devices to the user and a directionality of the gesture; and
perform an operation for detecting the gesture using the selected subset of the plurality of network devices.

22. The system of claim 21, wherein the circuitry configured to select the subset of the plurality of network devices based on the relative direction of each network device of the plurality of network devices to the user and the directionality of the gesture is configured to:
rank each of the plurality of network devices; and
select the subset of the plurality of network devices based on the ranking.

23. The system of claim 22, wherein the circuitry configured to rank each of the plurality of network devices is based on a number of independent paths for each of the plurality of network devices.

24. The system of claim 22, wherein the circuitry configured to rank each of the plurality of network devices is based on a channel state information (CSI) indicator matrix for each of the plurality of network devices.

25. The system of claim 24, wherein the circuitry configured to rank each of the plurality of network devices is based on a principal components analysis of the CSI indicator matrix for each of the plurality of network devices.

26. The system of claim 25, wherein the circuitry configured to rank each of the plurality of network devices is based on the principal components analysis of the CSI indicator matrix for each of the plurality of network devices, and the principal components analysis identifies a number of orthogonal wireless paths of communications for each of the plurality of network devices, and wherein a higher number of orthogonal wireless paths of communications for each of the plurality of network devices correlates with a higher ranking.

27. The system of claim 21, wherein the circuitry configured to select the subset of the plurality of network devices based on the relative direction of each network device of the plurality of network devices to the user and the directionality of the gesture is configured to:
in response to the gesture predominantly occurring in a transverse plane of a body of the user, select the subset of devices of the plurality of network devices oriented perpendicularly to the transverse plane;
in response to the gesture predominantly occurring in a coronal plane of the body of the user, select the subset of devices of the plurality of network devices oriented perpendicularly to the coronal plane; and
in response to the gesture predominantly occurring in a sagittal plane of a body of the user, select the subset of devices of the plurality of network devices oriented perpendicularly to the sagittal plane.

28. The system of claim 21, wherein the circuitry configured to select the subset of the plurality of network devices based on the relative direction of each network device of the plurality of network devices to the user and the directionality of the gesture is configured to:
prompt the user to perform the gesture; and
test each of the plurality of network devices.

29. The system of claim 28, wherein the circuitry configured to test each of the plurality of network devices is configured to test at least one of a received signal strength indicator (RSSI), a channel state information (CSI) indicator, a Doppler effect, or a frequency shift of each of the plurality of network devices.

30. The system of claim 29, wherein the circuitry configured to test each of the plurality of network devices is configured to test each of the RSSI, the CSI indicator, the Doppler effect, and the frequency shift of each of the plurality of network devices.

31. The system of claim 28, wherein the circuitry is configured to:
generate channel data for each of the plurality of network devices based on the testing,
wherein the circuitry configured to select the subset of the plurality of network devices based on the relative direction of each network device of the plurality of network devices to the user and the directionality of the gesture is configured to:
select the subset of the plurality of network devices based on the generated channel data.

32. The system of claim 31, wherein the circuitry configured to generate the channel data for each of the identified devices tested with the wireless parameter is configured to reduce a dimensionality of the channel data.

33. The system of claim 31, wherein the circuitry configured to select the subset of the plurality of network devices based on the generated channel data is further based on determining the channel data with a highest associated dimensionality.

34. The system of claim 31, wherein the circuitry configured to select the subset of the plurality of network devices is further based on determining a device associated with the generated channel data most affected by a gesture.

35. The system of claim 21, wherein the circuitry configured to identify the plurality of network devices within the range of the user performing the gesture is configured to filter the identified devices based on a proximity to the transmitter.

36. The system of claim 21, wherein the circuitry configured to identify the plurality of network devices within the range of the user performing the gesture is configured to filter the identified devices based on a strength of a signal.

37. The system of claim 21, wherein the circuitry is configured to:
initiate a gesture detection session;
wherein the circuitry configured to identify the plurality of network devices within the range of a user performing the gesture is configured to identify a paired device or pair with a nearby device;
transmit, from a transmitter of the plurality of network devices, a known pattern to the paired device;
receive, at the paired device, the known pattern and transmit a first response to the transmitter;
determine, at the transmitter, a first wireless parameter based on the response;
determine whether the wireless parameter meets a predetermined threshold;
reduce a dimensionality of the wireless parameter;
wherein the circuitry configured to select the subset of the plurality of network devices based on the relative direction of each network device of the plurality of network devices to the user and the directionality of the gesture is configured to select a device for gesture detection based on the wireless parameter having the reduced dimensionality;
receive, at the transmitter, a trigger for the gesture detection;
transmit the known pattern to the selected device;
receive, at the selected device, the known pattern and transmit a first response to the transmitter;
determine, at the transmitter, a second wireless parameter based on the second response;
transmit the second wireless parameter to a gesture detection system;
wherein the circuitry configured to perform the operation for detecting the gesture using the selected subset of the plurality of network devices is configured to determine, with the gesture detection system, an identification of a gesture based on a comparison of the second wireless pattern with a database of known gestures and known wireless parameters; and
receive, at the transmitter, the identification of the gesture.

38.-100. (canceled)
